(19) United States
(12) Patent Application Publication
(10) Pub. No.: US 2026/0162148 A1
(43) Pub. Date: Jun. 11, 2026

(54) SYSTEMS AND METHODS FOR REMOTE AUDIO-VISUAL MANIPULATION AND CONTENT CREATION

(71) Applicant: Bevsign LLC, Fair Lawn, NJ (US)

(72) Inventor: Daniel Levin, Fair Lawn, NJ (US)

(73) Assignee: Bevsign LLC, Fair Lawn, NJ (US)

(21) Appl. No.: 19/413,806

(22) Filed: Dec. 9, 2025

Related U.S. Application Data
(60) Provisional application No. 63/729,766, filed on Dec. 9, 2024.

(51) Int. Cl. G06Q 30/0241; G06Q 10/087; G06Q 30/0283

(52) U.S. Cl. CPC G06Q 30/0276; G06Q 10/08772; G06Q 30/0283

(57) ABSTRACT

A method for remote creation of dynamic advertisements, the method comprising: selecting, via user interaction with an application, one or more templates; scanning, via user interaction with one or more client devices implementing the application, one or more UPC codes, wherein each of the one or more UPC codes corresponds to a product comprising one or more products; selecting, from an external database, one or more images of the one or more products to import into the one or more templates, wherein the one or more imported images may be reconfigured within the one or more templates; publishing, the one or more templates, to create one or more advertisements; transmitting, via wireless communication between the one or more client devices and an external device, the one or more advertisements to the external device; and displaying, via a display of the external device, the one or more advertisements.

### CROSS-REFERENCE TO RELATED APPLICATION

The present application claims the benefit of priority to Provisional App. No. 63/729,766, for “SYSTEMS AND METHODS FOR REMOTE CREATION OF DYNAMIC ADVERTISEMENTS,” filed Dec. 9, 2024, the contents of which are incorporated by reference herein.

### FIELD OF THE PRESENT DISCLOSURE

The present disclosure is directed to systems and methods for remote creation of dynamic visual content. More specifically, the present disclosure is directed to systems and methods utilizing mobile devices to quickly, efficiently, and remotely create and display visual content.

### INTRODUCTION

In an increasingly competitive retail environment, the ability to quickly generate advertisements is crucial for local retailers. With rapidly shifting consumer demands, the rise of e-commerce, and the fast pace of the retail market, businesses must be agile in their marketing efforts to stay relevant and profitable.

Advertising plays a crucial role in shaping consumer behavior. Accordingly, one of the primary reasons retailers need to quickly generate advertisements is to efficiently manage their inventory. As an example, local retailers often operate with smaller inventories and less storage space than larger national chains. Thus, it becomes imperative that said retailers are able to sell stock quickly to avoid overstocking or retaining unsold items for too long, which directly contributes to higher overhead costs.

Quickly generated advertisements help retailers effectively promote overstocked or underperforming products, allowing them to sell these items before they become obsolete. Flash sales, clearance promotions, and limited-time offers can be effectively communicated through advertisements, driving immediate foot traffic, thus ensuring a steady turnover of stock.

Moreover, as consumer preferences change rapidly, retailers who are able to quickly assimilate to these shifts stand a better chance of maintaining customer loyalty and increasing sales. Meaning, the rapid generation of advertisements allows businesses to respond in real-time to trends, holidays, or seasonal needs. For example, during social media trends for particular drinks, a local liquor retailer can swiftly promote the requisite ingredients to make said drinks, thereby exploiting the fleeting nature of said trends. Additionally, advertisements generated in response to local events or community activities can attract targeted audiences and engage consumers in a timely manner. Local retailers that stay attuned to their community's needs and trends can provide relevant offers and promotions, enhancing their reputation and building stronger customer relationships.

Traditional digital media displays in retail storefronts suffer from significant technological limitations that hinder their effectiveness. Many existing systems rely on static content management approaches requiring technical expertise and physical access to display hardware for updates. These systems lack integration with inventory management and point-of-sale systems, creating disconnected workflows where retailers must manually coordinate between multiple systems to ensure promotional content reflects current product availability and pricing. The absence of streamlined product identification mechanisms, such as barcode scanning, forces retailers to manually input product information, increasing advertisement creation time and introducing potential data entry errors.

Conventional digital signage solutions fail to provide retailers with flexibility to rapidly respond to market conditions or trending products. These systems require pre-scheduled content updates or involve cumbersome approval processes that prevent real-time modifications. The lack of cloud-based content libraries containing pre-existing product imagery necessitates that retailers source, edit, and format their own visual assets, adding substantial time to the advertisement creation process. Many traditional systems do not offer intuitive template-based design tools accessible via mobile applications, limiting retailers'ability to create professional-quality advertisements without specialized design skills. These technological gaps result in missed sales opportunities, as retailers struggle to capitalize on fleeting trends or adjust promotional strategies in response to inventory levels and consumer demand.

Accordingly, it would be beneficial to provide retailers with systems and methods enabling remote creation of dynamic visual content. It would be further beneficial to allow said retailers to generate visual content in real-time to meet consumer demand for particular products.

### SUMMARY

This Summary is provided to introduce a selection of concepts in a simplified form that are further described below in the Detailed Description. This Summary is not intended to identify key features or essential features, nor is it intended to limit the scope of the claims included herewith.

According to an aspect of the present disclosure, a system for remote creation of dynamic advertisements may be provided. The system may comprise a client device configured to execute a program, wherein the client device may be configured to receive selection of one or more templates via the program, scan one or more scannable elements via the program, wherein each of the one or more scannable elements may uniquely correspond to a product, retrieve from an external database one or more images of the one or more products to import into the one or more templates, wherein the one or more imported images may be reconfigured within the one or more templates, publish the one or more templates to create one or more advertisements, and transmit via wireless communication the one or more advertisements. The system may further comprise an external device comprising a display, wherein the external device may be configured to receive the one or more advertisements from the client device via the wireless communication and display the one or more advertisements on the display.

According to other aspects of the present disclosure, the system may include one or more of the following features. The external database may be stored on a cloud computing platform and may comprise a relational database structure with indexed fields including UPC codes, product categories, brand names, and SKU numbers for beverage alcohol products, and the external database may store the one or more images. The program may be a mobile application configured to access a camera of the client device for barcode scanning functionality and to interface with local device storage for multimedia file access. The client device may be configured to integrate with an inventory management system via API calls to retrieve real-time inventory levels, current pricing data, and sales performance metrics for automatic advertisement content population. The client device may be further configured to create one or more playlists comprising the one or more advertisements, and the external device may be configured to display the one or more playlists in a continuous loop format. The one or more templates may comprise configurable components including pixel-coordinate image placement zones, font-specific text field positions for pricing information, and frame-based display duration parameters ranging from 3 to 15 seconds per template scene. The program may include one or more stores, wherein each store of the one or more stores may correspond to a physical retail location and may be accessible remotely via the client device. Each store of the one or more stores may include one or more screens corresponding to individual external devices, and the client device may be configured to remotely monitor and control the one or more screens. The client device may be configured to display real-time status information for each screen of the one or more screens, wherein the real-time status information may indicate whether each screen is active or inactive based on network connectivity between the system and the corresponding external device. The one or more advertisements may comprise multi-product advertisements, wherein each multi-product advertisement may include a representative image displaying a plurality of products, one or more product markers positioned on the representative image to indicate locations of individual products, and one or more product modules each associated with a corresponding product marker, wherein each product module may include a product selection field, a price field, and a discount field, and the client device may be configured to map each product module to its corresponding product marker in a final rendered advertisement. The program may be configured to display a main stores interface comprising one or more store buttons each corresponding to a store of the one or more stores, wherein selection of a store button may generate a specific store interface displaying one or more screen panels each corresponding to an individual external device at the selected store, wherein selection of a screen panel may generate a screen-playlist interface displaying one or more playlist panels and a display toggle, and the client device may be configured to display real-time connectivity status for each screen panel indicating whether the corresponding external device maintains an active network connection with the system. The one or more playlists may comprise a playlist data structure including content references to the one or more advertisements and one or more multimedia files, display duration parameters individually assigned to each content reference, sequencing information defining playback order, and transition effects between content elements, wherein the playlist data structure may be stored in a database accessible by the client device, and the external device may be configured to receive the playlist data structure, resolve the content references to obtain corresponding multimedia content, and execute sequential playback according to the display duration parameters and sequencing information.

According to another aspect of the present disclosure, a system for remote creation of dynamic advertisements may be provided. The system may comprise a client device configured to execute an application, wherein the client device may be configured to activate a camera of the client device via the application, capture an image of a scannable element associated with a product via the camera, extract a product identifier from the captured image of the scannable element, transmit the product identifier to a server via wireless communication, receive from the server product data associated with the product identifier, wherein the product data may comprise a product name, pricing information, and one or more stock images, automatically populate with at least one of the product data an advertisement template to generate an advertisement for the product, and transmit via wireless communication the advertisement to an external device. The system may further comprise the external device comprising a display, wherein the external device may be configured to receive the advertisement from the client device via the wireless communication and display the advertisement on the display.

According to other aspects of the present disclosure, the system may include one or more of the following features. The system may further comprise a server communicatively coupled to a cloud-based database, wherein the server may be configured to receive the product identifier from the client device, query the cloud-based database using the product identifier to retrieve the product data, and transmit the product data to the client device. The cloud-based database may store product information for a plurality of beverage alcohol products, wherein the product information may comprise product identifiers, product names, pricing data, and stock images for each product of the plurality of beverage alcohol products. The client device may be further configured to create a playlist comprising the advertisement and transmit the playlist to the external device, and the external device may be configured to display the playlist in a continuous loop format. The playlist may comprise branded content provided by third-party suppliers, wherein the branded content may comprise pre-produced video advertisements. The advertisement template may comprise configurable components including image placement zones, text field positions for pricing information, and display duration parameters, and the client device may be configured to allow manual modification of the automatically populated product data within the advertisement template.

According to another aspect of the present disclosure, a system for remote multi-location screen management may be provided. The system may comprise a client device configured to execute a mobile application, wherein the client device may be configured to display a stores interface comprising one or more store buttons, wherein each store button of the one or more store buttons may correspond to a physical retail location, receive selection of a store button from the one or more store buttons, display a store interface comprising one or more screen panels, wherein each screen panel of the one or more screen panels may correspond to an individual external device at the physical retail location associated with the selected store button, and display real-time status information for each screen panel of the one or more screen panels, wherein the real-time status information may indicate whether the corresponding external device is active or inactive based on network connectivity.

According to other aspects of the present disclosure, the system may include one or more of the following features. The client device may be configured to receive selection of a screen panel from the one or more screen panels, display a screen-playlist interface comprising one or more playlist panels and a display toggle associated with the selected screen panel, receive user input via the display toggle to activate or deactivate content display on the external device corresponding to the selected screen panel, and transmit via wireless communication a display command to the external device based on the user input. The system may further comprise one or more external devices, wherein each external device of the one or more external devices may comprise a display and may be configured to receive the display command from the client device via the wireless communication, activate or deactivate content display on the display based on the display command, and transmit status data to the client device indicating network connectivity status.

In an embodiment, there may be provided a method for remote creation of dynamic advertisements, wherein the method may comprise: selecting one or more templates via user interaction with an application, scanning one or more UPC codes via user interaction with one or more client devices implementing the application, wherein each of the one or more UPC codes may correspond to a product comprising one or more products; selecting one or more images of the one or more products to import into the one or more templates from an external database, wherein the one or more imported images may be reconfigured within the one or more templates; publishing, the one or more templates, thus creating one or more advertisements; transmitting the one or more advertisements to an external device via wireless communication between the one or more client devices and said device; and displaying the one or more advertisements on a display of the external device.

In an embodiment, the external database may be stored on a cloud computing platform. Additionally, the application may be at least one of a web-based application and a mobile application. Moreover, wireless communication between the one or more client devices and the external device may be achieved via Bluetooth. Lastly, the application may integrate with a point-of-sale system.

According to another aspect of the present disclosure, a method for remote creation of dynamic advertisements may be provided. The method may comprise activating a scanning interface via an application, capturing an image of a scannable element associated with a product, receiving from a database product data based on the product, wherein the product data may comprise at least one product image and product information, receiving selection of an advertisement template comprising one or more unpopulated product representations, one or more unpopulated product markers, and one or more unpopulated product prices, wherein the one or more unpopulated product representations, the one or more unpopulated product markers, and the one or more unpopulated product prices may define spatial regions designated to receive content, automatically populating the one or more unpopulated product representations with the at least one product image to transform the one or more unpopulated product representations into one or more populated product representations, automatically populating the one or more unpopulated product prices with a product price from the product information to transform the one or more unpopulated product prices into one or more populated product prices, wherein each of the one or more populated product prices may be populated within one of the one or more unpopulated product markers to transform the one or more unpopulated product markers to one or more populated product markers, generating an advertisement comprising the one or more populated product representations, the one or more populated product markers, and the one or more populated product prices, and transmitting the generated advertisement to an external device comprising a display.

According to other aspects of the present disclosure, the method may include one or more of the following features. The advertisement template may further comprise an unpopulated background region that may be populated with background imagery or color scheme data to transform the unpopulated background region into a populated background region, and the advertisement template may further comprise one or more unpopulated text fields defining spatial regions designated to receive textual content, wherein the one or more unpopulated text fields may be automatically populated to transform the one or more unpopulated text fields into one or more populated text fields, wherein the one or more populated text fields may comprise at least one of product names, product descriptions, promotional messaging, or category identifiers.

### BRIEF DESCRIPTION OF THE DRAWINGS

The following drawings, which are incorporated in and constitute a part of this specification exemplify the aspects of the present disclosure and, together with the description, explain and illustrate principles of this disclosure.

FIG. 1 illustrates an embodiment of an environment in which the present disclosure may be practiced.

FIG. 2 illustrates an embodiment of a block diagram of an electronic device.

FIG. 3 illustrates an embodiment of a system for remote creation of dynamic advertisements.

FIG. 4 illustrates an embodiment of the system for remote creation of dynamic advertisements.

FIG. 5 illustrates an embodiment of a playlist creation method.

FIG. 6 illustrates an embodiment of a method for remote creation of dynamic advertisements.

FIG. 8 illustrates an embodiment of a main playlist interface that includes a store panel, playlist panel, scan product button, manual product entry button, and new playlist button for managing advertisement content.

FIG. 9 illustrates another view of an embodiment of the main playlist interface showing the playlist panel populated with multiple playlists, including a default playlist and specialized playlists such as wine and cognac.

FIG. 10 illustrates an embodiment of a main stores interface that displays one or more store buttons representing different store locations for managing multiple retail establishments.

FIG. 11 illustrates an embodiment of a specific store interface that includes one or more screen panels corresponding to individual display screens at a selected store location.

FIG. 12 illustrates an embodiment of a screen-playlist interface that includes one or more used playlist panels and a display toggle for activating content display on the associated screen.

FIG. 13 illustrates an embodiment of a default template interface that displays available advertisement templates for user selection during the advertisement creation process.

FIG. 14 illustrates an embodiment of a scanner interface that provides barcode scanning functionality with a scanning frame overlaid on a product image for UPC code recognition.

FIG. 15 illustrates an embodiment of a product search interface that presents a searchable list of products with a filter selector positioned at the top for refining search results.

FIGS. 16-21 illustrate an embodiment of a new playlist creation workflow across a number of sequential interfaces, including playlist naming, content selection, ordering, and confirmation steps.

FIG. 22 illustrates an embodiment of a main template interface that includes one or more template panels displaying various advertisement template options available for selection.

FIG. 23 illustrates an embodiment of a playlist-template addition interface that demonstrates the process of adding a selected template to a playlist within the application workflow.

FIG. 24 illustrates an embodiment of an advertisement generation interface that includes a representative product image, product selection buttons, text fields for title and subtitle, pricing fields, and options for adding to playlists or saving to advertisement archives.

FIG. 25 illustrates an embodiment of a multi-product advertisement generation interface that includes a representative image with product markers, master title and subtitle fields, multiple product modules with individual pricing and discount fields, and playlist addition capabilities.

FIGS. 26A-26C illustrate an embodiment of a process for uploading content to the system.

FIGS. 27A-27B illustrate an example of an unpopulated template and a populated template.

### DETAILED DESCRIPTION

In the following detailed description, reference will be made to the accompanying drawing(s), in which identical functional elements are designated with like numerals. The aforementioned accompanying drawings show by way of illustration, and not by way of limitation, specific aspects, and implementations consistent with principles of this disclosure. These implementations are described in sufficient detail to enable those skilled in the art to practice the disclosure and it is to be understood that other implementations may be utilized and that structural changes and/or substitutions of various elements may be made without departing from the scope and spirit of this disclosure. The following detailed description is, therefore, not to be construed in a limited sense.

It is noted that description herein is not intended as an extensive overview, and as such, concepts may be simplified in the interests of clarity and brevity.

All documents mentioned in this application are hereby incorporated by reference in their entirety. Any process described in this application may be performed in any order and may omit any of the steps in the process. Processes may also be combined with other processes or steps of other processes.

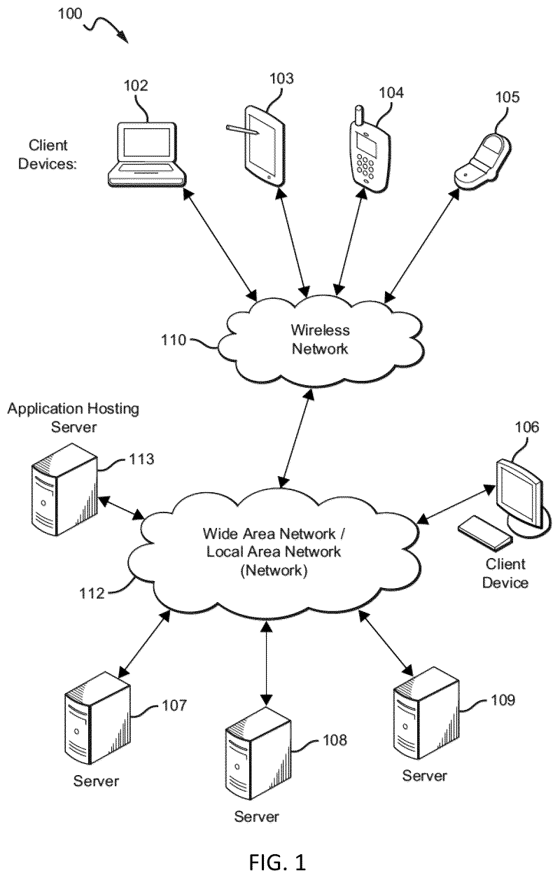

FIG. 1 illustrates components of one embodiment of an environment in which the present disclosure may be practiced. Not all of the components may be required to practice the present disclosure, and variations in the arrangement and type of the components may be made without departing from the spirit or scope of the present disclosure. As shown, the system 100 includes one or more Local Area Networks (“LANs”)/Wide Area Networks (“WANs”) 112, one or more wireless networks 110, one or more wired or wireless client devices 106, mobile or other wireless client devices 102-105, servers 107-109, and may include or communicate with one or more data stores or databases. The client devices 102-106 may include, for example, at least one of desktop computers, laptop computers, set top boxes, tablets, cell phones, smart phones, smart speakers, wearable devices (such as the Apple Watch) and the like. Servers 107-109 can include, for example, one or more application servers, content servers, search servers, and the like. FIG. 1 also illustrates application hosting server 113.

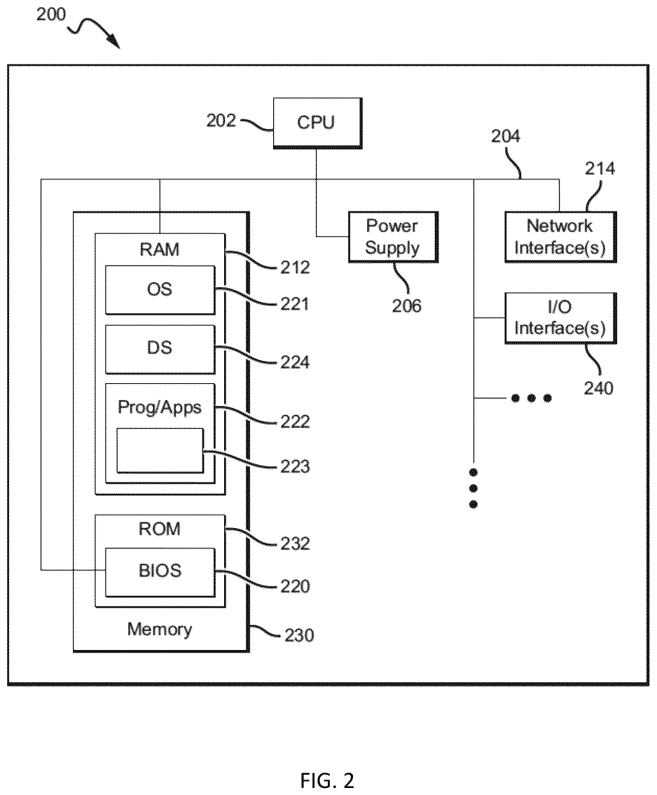

FIG. 2 illustrates a block diagram of an electronic device 200 that can implement one or more aspects of at least one of an apparatus, system and method for remote creation of dynamic advertisements (the “Engine”) according to one embodiment of the present disclosure. Instances of the electronic device 200 may include servers, e.g., servers 107-109, and client devices, e.g., client devices 102-106. In general, the electronic device 200 can include a processor/CPU 202, memory 230, a power supply 206, and input/output (I/O) components/devices 240, e.g., microphones, speakers, displays, touchscreens, keyboards, mice, keypads, microscopes, GPS components, cameras, heart rate sensors, light sensors, accelerometers, targeted biometric sensors, etc., which may be operable, for example, to provide graphical user interfaces or text user interfaces.

A user may provide input via a touchscreen of an electronic device 200. A touchscreen may determine whether a user is providing input by, for example, determining whether the user is touching the touchscreen with a part of the user's body such as his or her fingers. The electronic device 200 can also include a communications bus 204 that connects the aforementioned elements of the electronic device 200. Network interfaces 214 can include a receiver and a transmitter (or transceiver), and one or more antennas for wireless communications.

The processor 202 can include one or more of any type of processing device, e.g., a Central Processing Unit (CPU), and a Graphics Processing Unit (GPU). Also, for example, the processor can be central processing logic, or other logic, may include hardware, firmware, software, or combinations thereof, to perform one or more functions or actions, or to cause one or more functions or actions from one or more other components. Also, based on a desired application or need, central processing logic, or other logic, may include, for example, a software-controlled microprocessor, discrete logic, e.g., an Application Specific Integrated Circuit (ASIC), a programmable/programmed logic device, memory device containing instructions, etc., or combinatorial logic embodied in hardware. Furthermore, logic may also be fully embodied as software.

The memory 230, which can include Random Access Memory (RAM) 212 and Read Only Memory (ROM) 232, can be enabled by one or more of any type of memory device, e.g., a primary (directly accessible by the CPU) or secondary (indirectly accessible by the CPU) storage device (e.g., flash memory, magnetic disk, optical disk, and the like). The RAM can include an operating system 221, data storage 224, which may include one or more databases, and programs and/or applications 222, which can include, for example, software aspects of the program 223. The ROM 232 can also include Basic Input/Output System (BIOS) 220 of the electronic device.

Software aspects of the program 223 are intended to broadly include or represent all programming, applications, algorithms, models, software and other tools necessary to implement or facilitate methods and systems according to embodiments of the present disclosure. The elements may exist on a single computer or be distributed among multiple computers, servers, devices or entities.

The power supply 206 contains one or more power components and facilitates supply and management of power to the electronic device 200.

The input/output components, including Input/Output (I/O) interfaces 240, can include, for example, any interfaces for facilitating communication between any components of the electronic device 200, components of external devices (e.g., components of other devices of the network or system 100), and end users. For example, such components can include a network card that may be an integration of a receiver, a transmitter, a transceiver, and one or more input/output interfaces. A network card, for example, can facilitate wired or wireless communication with other devices of a network. In cases of wireless communication, an antenna can facilitate such communication. Also, some of the input/output interfaces 240 and the bus 204 can facilitate communication between components of the electronic device 200, and in an example can ease processing performed by the processor 202.

Where the electronic device 200 is a server, it can include a computing device that can be capable of sending or receiving signals, e.g., via a wired or wireless network, or may be capable of processing or storing signals, e.g., in memory as physical memory states. The server may be an application server that includes a configuration to provide one or more applications, e.g., aspects of the Engine, via a network to another device. Also, an application server may, for example, host a web site that can provide a user interface for administration of example aspects of the Engine. The Engine may facilitate the remote creation, management, and deployment of dynamic advertisements for retail environments by enabling users to scan product identifiers, retrieve product information from databases, populate customizable templates with product imagery and pricing data, and transmit completed advertisements to external display devices for presentation to customers. The Engine may further provide playlist management functionality that allows users to organize multiple advertisements and multimedia content into sequential presentations, schedule content delivery across multiple store locations and display screens, and remotely monitor the operational status of their digital signage network through a centralized application interface.

Any computing device capable of sending, receiving, and processing data over a wired and/or a wireless network may act as a server, such as in facilitating aspects of implementations of the Engine. Thus, devices acting as a server may include devices such as dedicated rack-mounted servers, desktop computers, laptop computers, set top boxes, integrated devices combining one or more of the preceding devices, and the like.

Servers may vary widely in configuration and capabilities, but they generally include one or more central processing units, memory, mass data storage, a power supply, wired or wireless network interfaces, input/output interfaces, and an operating system such as Windows Server, Mac OS X, Unix, Linux, FreeBSD, and the like.

A server may include, for example, a device that is configured, or includes a configuration, to provide data or content via one or more networks to another device, such as in facilitating aspects of an example apparatus, system and method of the Engine. One or more servers may, for example, be used in hosting a Web site, such as the web site www. microsoft. com. One or more servers may host a variety of sites, such as, for example, business sites, informational sites, social networking sites, educational sites, wikis, financial sites, government sites, personal sites, and the like.

Servers may also, for example, provide a variety of services, such as Web services, third-party services, audio services, video services, email services, HTTP or HTTPS services, Instant Messaging (IM) services, Short Message Service (SMS) services, Multimedia Messaging Service (MMS) services, File Transfer Protocol (FTP) services, Voice Over IP (VOIP) services, calendaring services, phone services, and the like, all of which may work in conjunction with example aspects of an example systems and methods for the apparatus, system and method embodying the Engine. Content may include, for example, text, images, audio, video, and the like.

In example aspects of the apparatus, system and method embodying the Engine, client devices may include, for example, any computing device capable of sending and receiving data over a wired and/or a wireless network. Such client devices may include desktop computers as well as portable devices such as cellular telephones, smart phones, display pagers, Radio Frequency (RF) devices, Infrared (IR) devices, Personal Digital Assistants (PDAs), handheld computers, GPS-enabled devices tablet computers, sensor-equipped devices, laptop computers, set top boxes, wearable computers such as the Apple Watch and Fitbit, integrated devices combining one or more of the preceding devices, and the like.

Client devices such as client devices 102-106, as may be used in an example apparatus, system and method embodying the Engine, may range widely in terms of capabilities and features. For example, a cell phone, smart phone or tablet may have a numeric keypad and a few lines of monochrome Liquid-Crystal Display (LCD) display on which only text may be displayed. In another example, a Web-enabled client device may have a physical or virtual keyboard, data storage (such as flash memory or SD cards), accelerometers, gyroscopes, respiration sensors, body movement sensors, proximity sensors, motion sensors, ambient light sensors, moisture sensors, temperature sensors, compass, barometer, fingerprint sensor, face identification sensor using the camera, pulse sensors, heart rate variability (HRV) sensors, beats per minute (BPM) heart rate sensors, microphones (sound sensors), speakers, GPS or other location-aware capability, and a 2D or 3D touch-sensitive color screen on which both text and graphics may be displayed. In some embodiments multiple client devices may be used to collect a combination of data. For example, a smart phone may be used to collect movement data via an accelerometer and/or gyroscope and a smart watch (such as the Apple Watch) may be used to collect heart rate data. The multiple client devices (such as a smart phone and a smart watch) may be communicatively coupled.

Client devices, such as client devices 102-106, for example, as may be used in an example apparatus, system and method implementing the Engine, may run a variety of operating systems, including personal computer operating systems such as Windows, iOS or Linux, and mobile operating systems such as iOS, Android, Windows Mobile, and the like. Client devices may be used to run one or more applications that are configured to send or receive data from another computing device. Client applications may provide and receive textual content, multimedia information, and the like. Client applications may perform actions such as browsing webpages, using a web search engine, interacting with various apps stored on a smart phone, sending and receiving messages via email, SMS, or MMS, playing games (such as fantasy sports leagues), receiving advertising, watching locally stored or streamed video, or participating in social networks.

In example aspects of the apparatus, system and method implementing the Engine, one or more networks, such as networks 110 or 112, for example, may couple servers and client devices with other computing devices, including through wireless network to client devices. A network may be enabled to employ any form of computer readable media for communicating information from one electronic device to another. The computer readable media may be non-transitory. A network may include the Internet in addition to Local Area Networks (LANs), Wide Area Networks (WANs), direct connections, such as through a Universal Serial Bus (USB) port, other forms of computer-readable media (computer-readable memories), or any combination thereof. On an interconnected set of LANs, including those based on differing architectures and protocols, a router acts as a link between LANs, enabling data to be sent from one to another.

Communication links within LANs may include twisted wire pair or coaxial cable, while communication links between networks may utilize analog telephone lines, cable lines, optical lines, full or fractional dedicated digital lines including T1, T2, T3, and T4, Integrated Services Digital Networks (ISDNs), Digital Subscriber Lines (DSLs), wireless links including satellite links, optic fiber links, or other communications links known to those skilled in the art. Furthermore, remote computers and other related electronic devices could be remotely connected to either LANs or WANs via a modem and a telephone link.

A wireless network, such as wireless network 110, as in an example apparatus, system and method implementing the Engine, may couple devices with a network. A wireless network may employ stand-alone ad-hoc networks, mesh networks, Wireless LAN (WLAN) networks, cellular networks, and the like.

A wireless network may further include an autonomous system of terminals, gateways, routers, or the like connected by wireless radio links, or the like. These connectors may be configured to move freely and randomly and organize themselves arbitrarily, such that the topology of wireless network may change rapidly. A wireless network may further employ a plurality of access technologies including 2nd (2 G), 3rd (3 G), 4th (4 G) generation, Long Term Evolution (LTE) radio access for cellular systems, WLAN, Wireless Router (WR) mesh, and the like. Access technologies such as 2G, 2.5G, 3G, 4G, and future access networks may enable wide area coverage for client devices, such as client devices with various degrees of mobility. For example, a wireless network may enable a radio connection through a radio network access technology such as Global System for Mobile communication (GSM), Universal Mobile Telecommunications System (UMTS), General Packet Radio Services (GPRS), Enhanced Data GSM Environment (EDGE), 3GPP Long Term Evolution (LTE), LTE Advanced, Wideband Code Division Multiple Access (WCDMA), Bluetooth, 802.11b/g/n, and the like. A wireless network may include virtually any wireless communication mechanism by which information may travel between client devices and another computing device, network, and the like.

Internet Protocol (IP) may be used for transmitting data communication packets over a network of participating digital communication networks, and may include protocols such as TCP/IP, UDP, DECnet, NetBEUI, IPX, Appletalk, and the like. Versions of the Internet Protocol include IPv4 and IPv6. The Internet includes local area networks (LANs), Wide Area Networks (WANs), wireless networks, and long-haul public networks that may allow packets to be communicated between the local area networks. The packets may be transmitted between nodes in the network to sites each of which has a unique local network address. A data communication packet may be sent through the Internet from a user site via an access node connected to the Internet. The packet may be forwarded through the network nodes to any target site connected to the network provided that the site address of the target site is included in a header of the packet. Each packet communicated over the Internet may be routed via a path determined by gateways and servers that switch the packet according to the target address and the availability of a network path to connect to the target site.

The header of the packet may include, for example, the source port (16 bits), destination port (16 bits), sequence number (32 bits), acknowledgement number (32 bits), data offset (4 bits), reserved (6 bits), checksum (16 bits), urgent pointer (16 bits), options (variable number of bits in multiple of 8 bits in length), padding (may be composed of all zeros and includes a number of bits such that the header ends on a 32 bit boundary). The number of bits for each of the above may also be higher or lower.

A “content delivery network” or “content distribution network” (CDN), as may be used in an example apparatus, system and method implementing the Engine, generally refers to a distributed computer system that comprises a collection of autonomous computers linked by a network or networks, together with the software, systems, protocols and techniques designed to facilitate various services, such as the storage, caching, or transmission of content, streaming media and applications on behalf of content providers. Such services may make use of ancillary technologies including, but not limited to, “cloud computing,” distributed storage, DNS request handling, provisioning, data monitoring and reporting, content targeting, personalization, and business intelligence. A CDN may also enable an entity to operate and/or manage a third party's web site infrastructure, in whole or in part, on the third party's behalf.

A Peer-to-Peer (or P2P) computer network relies primarily on the computing power and bandwidth of the participants in the network rather than concentrating it in a given set of dedicated servers. P2P networks are typically used for connecting nodes via largely ad hoc connections. A pure peer-to-peer network does not have a notion of clients or servers, but only equal peer nodes that simultaneously function as both “clients” and “servers” to the other nodes on the network.

Embodiments of the present disclosure include apparatuses, systems, and methods implementing the Engine. Embodiments of the present disclosure may be implemented on one or more of client devices 102-106, which are communicatively coupled to servers including servers 107-109. Moreover, client devices 102-106 may be communicatively (wirelessly or wired) coupled to one another. In particular, software aspects of the Engine may be implemented in the program 223. The program 223 may be implemented on one or more client devices 102-106, one or more servers 107-109, and 113, or a combination of one or more client devices 102-106, and one or more servers 107-109 and 113.

In an embodiment, the system may receive, process, generate and/or store time series data. The system may include an application programming interface (API). The API may include an API subsystem. The API subsystem may allow a data source to access data. The API subsystem may allow a third-party data source to send the data. In one example, the third-party data source may send JavaScript Object Notation (“JSON”)-encoded object data. In an embodiment, the object data may be encoded as XML-encoded object data, query parameter encoded object data, or byte-encoded object data.

The present disclosure is directed to both systems and methods for remote creation of dynamic advertisements. In an embodiment, the system for remote creation of dynamic advertisements (the “system”) 300 may enable a user to quickly create one or more advertisements. Resultingly, the system 300 is configured to facilitate increased sales and improved management of the user's inventory of one or more products. To illustrate, a retail store owner may employ the system 300 to swiftly create one or more advertisements for a particular product to exploit fleeting trends for said product. Moreover, the system 300 may be configured to increase foot traffic at a user's storefront by increasing consumer awareness of said storefront.

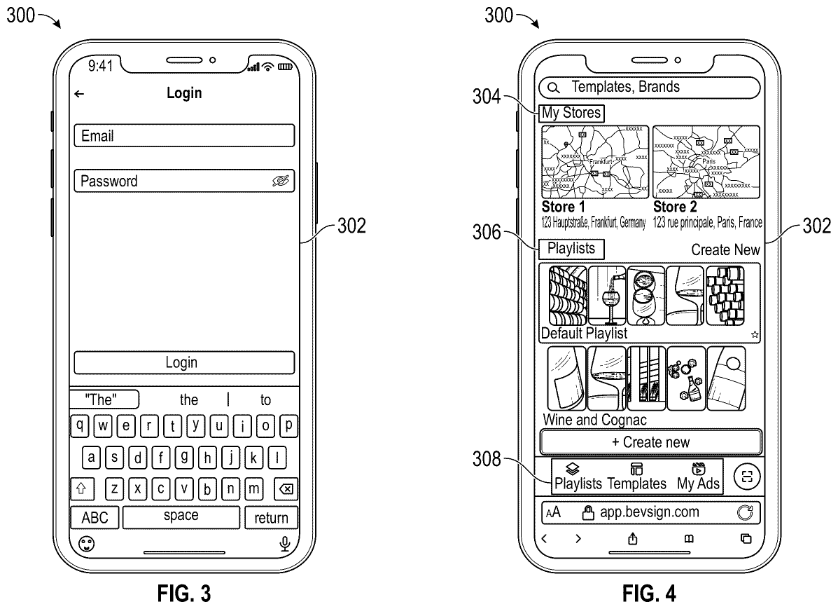

Turning to FIG. 3, the system 300 may be comprised of an application 302. In an embodiment, the application 302 may be at least one of a mobile application and a web-based application. For example, the mobile application may be accessed via download from an app store (e.g., Apple's App Store, Google Play Store, etc.), whereas the web-based application may be accessed via a web browser (e.g., Google Chrome, Safari, etc.). However, the application may be accessible via both the app store and the web browser. In various embodiments, the application 302 may be implemented as a downloadable native application, a progressive web application (PWA), or any other suitable software format or distribution mechanism. The application 302 may be executed on any suitable computing device, including but not limited to smartphones, tablet computers, desktop computers, or other comparable hardware platforms capable of running the application. The one or more client devices 102-106 described above may be adapted to run the application 302. To illustrate, upon download of the application 302, via the app store, the user may interact with the application 302 with one or more client devices 102-106.

The application 302 may include a front-facing graphical user interface. The user interface may be navigable by a user to access various components and modules (e.g., an account creation page, a login page, etc.) of the application 302. For example, during a first instance of interacting with the application 302, the user may be required to create an account on the account creation page. Subsequently, the user may be directed to the login page whenever the user opens the application 302 after creating the account.

Moving to FIG. 4, the application 302 may be further comprised of a home screen. In an embodiment, the home screen may be configured to display a stores panel 304, a playlist panel 306, and/or a navigation toolbar 308. As described in more detail below, the stores panel 304 may display each of the stores 310 stored in the database, the playlist panel 306 may display each of the playlists 312 stored in the database, and/or the navigational toolbar 308 may display one or more tools for inducing an action in the application 304.

The system may be configured to receive, from the user, one or more locations to the application 302, wherein said locations correspond to one or more storefronts owned by the user. As an illustration, if the user owns two storefronts, one in Frankfurt, Germany and the other in Paris, France, the user may input the address of said storefronts into the application 302, wherein the storefronts will then be displayed as the one or more user stores om the stores panel 304.

As used herein, the term “template” may refer to an editable design framework that provides a foundation for creating advertisements. A template may include predefined visual elements, placeholder regions for content insertion, and configurable parameters such as image placement zones, text field positions, background designs, and display duration settings. Templates may be categorized according to specific themes such as holiday celebrations, product categories, or promotional concepts, enabling users to select designs that align with their marketing objectives. Once a template is modified with specific product information and customized content, it may be saved as an advertisement.

As used herein, the term “ad” or “advertisement” may refer to the final product created after a template has been edited and saved by a user. An advertisement may include populated content such as product images, pricing information, promotional text, and discount details that have been inserted into the template structure. The advertisement represents a complete promotional piece that can be added to playlists, stored in an advertisement library, or transmitted to external display devices for presentation to customers.

As used herein, the term “playlist” may refer to a collection of advertisements and multimedia content configured to be played consecutively on a display device. A playlist may include multiple advertisements, videos, or images arranged in a specific sequence, with each element assigned an individual display duration. The playlist may be scheduled for continuous loop playback on the external device. Playlists may be created and managed by users through the application interface, and may be assigned to specific screens or store locations for targeted content delivery.

The terms “ad” and “advertisement” as used herein may encompass any visual or audio-visual content intended for display purposes, and should not be construed as limited to content having commercial or financial objectives, but rather may refer broadly to the visual representation and transmission of displayable files regardless of their underlying purpose or message.

The application 302 may display one or more playlists 312 in the playlist panel 306. In another embodiment, the user may create the one or more playlists 312 while interacting with the application 302 via a playlist creation method 400 (described in more detail below). For example, the user may be directed to a playlist creation page, via the navigation toolbar 308. In a further embodiment, the system 300 may integrate with one or more Point of Sale (“POS”) systems. In such an embodiment, the system 300 may autogenerate one or more user playlists 312 and/or one or more advertisements based on the bestselling and/or trending products at the one or more stores 310. The system 300 may be configured to interoperate with one or more POS systems by utilizing the POS′ APIs to facilitate bidirectional data exchange. Through such API-mediated communication channels, data (including, optionally, associated metadata) residing within the POS datastore may be retrieved by the system 300 on an as-needed basis for real-time processing. In certain implementations, the system 300 may execute bulk-ingestion routines to import entire data sets from the POS, thereby enabling comprehensive local analysis and indexing. In alternative implementations, the system 300 may perform parameter-driven selective ingestion, for example, retrieving only those data fields necessary for generating a given advertisement. Such a schema may optimize computational efficiency and reduce unnecessary data transfer overhead. As a nonlimiting example, the system 300 may import all data related to UPCs, Item Numbers, quantity of items, wholesale cost of said items, retail price of said items, and the like.

In a further embodiment, the application 302 may display the navigation toolbar 308, wherein said toolbar 308 facilitates improved navigation of the application 302. For example, the navigation toolbar 308 may display a plurality of options, wherein each of the options corresponds to one of the various components comprising the user interface of the application 302. In a further nonlimiting example, the navigation toolbar 308 may be comprised of an option to access at least one of the one or more stores 310, the one or more playlists 312, one or more advertisement templates, and one or more advertisements.

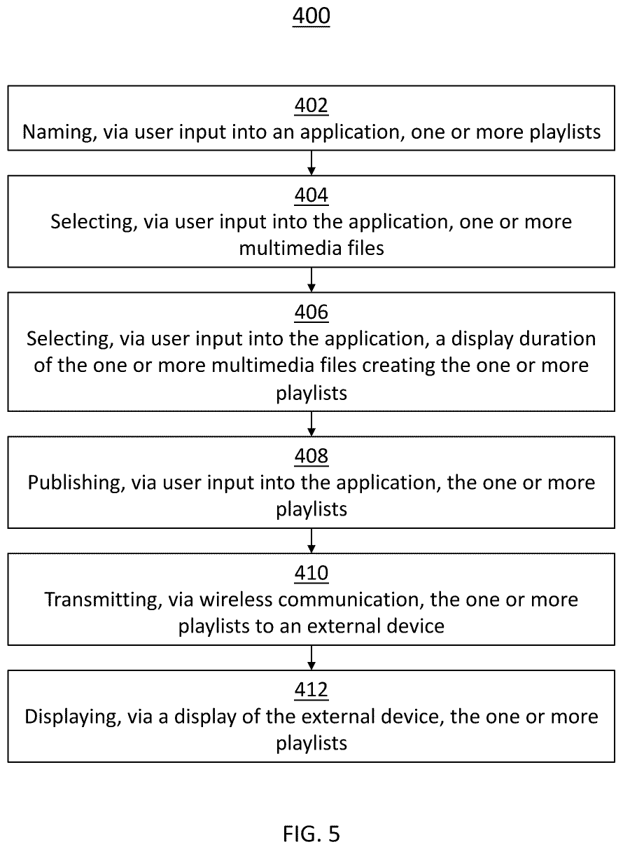

Referring to FIG. 5, the one or more playlists 312 may be created via the playlist creation method 400. The method 400 may be executed on the client device 102-105, which may be configured to perform local processing steps necessary to initiate and advance the method 400 workflow. For operations requiring additional data resources or specialized services, the client device 102-106 may interface with and invoke corresponding server-side (e.g., with servers 107-109 and 113) components to perform the requisite actions needed to achieve the desired result of the method 400.

In an embodiment, the playlist creation method 400 may be comprised of a first step 402, wherein the user is prompted to name one of the one or more user playlists 312. Such a name may be stored in the system 300 and may be displayed in relation to said playlist 312 in the playlist panel 306.

In a second step 404 of said playlist creation method 400, upon naming said playlist 312, the application 302 may prompt the user to select one or more multimedia files (e.g., photographs, videos, etc.). For example, the application 302 may be integrated with the one or more stores'310 POS, wherein the application 302 may prompt the user to create a particular playlist based upon sales data. To this effect, the system 300 may include a recommendation engine configured to generate advertisement or playlist element recommendations based on data derived from user selections. For example, when a user selects a given item or inputs a given multimedia file, the recommendation engine may analyze the associated data attributes of that said item or multimedia file. Using this analysis, the recommendation engine may determine, from the available templates, which are optimally suited for said item or multimedia file based on its specific properties or classification (e.g., the item classification is wine, the item classification is whiskey, or the multimedia file is a video file).

In an embodiment, the user may select the one or more advertisements after said advertisements have been published (described in more detail below), as well as the one or more multimedia files. In yet another embodiment, the application 302 may integrate with the one or more client devices 102-106, such that the application 302 may access the one or more multimedia files stored on said client devices 102-106 (e.g., allowing the application 302 permission to access images stored on a user's smart phone or desktop computer). Furthermore, the application may integrate with the web browser, such that the one or more multimedia files may be selected from the internet.

In a third step 406, after selecting the one or more multimedia files and/or the one or more advertisements, the application 302 may prompt the user to select a duration that said files and/or advertisements will be displayed in the final playlist. As a nonlimiting example, if the user selects three multimedia files and two advertisements, the user may be prompted, via the application 302, to select a duration that each file and advertisement will be displayed (e.g., 5 seconds, 10 seconds, etc.).

The playlist operates as a sequential multimedia presentation system, wherein the user may configure said playlist to display targeted promotional content designed to engage potential customers and drive retail traffic.

The playlist creation method 400 may be further comprised of a fourth step 408, wherein after creation, the user may publish the one or more playlists 312 within the application 302. In such an embodiment, upon publication, the one or more playlists 312 may be stored within the application 302, such that the user may access said playlists 312 at any point in time after creation.

In one embodiment, the completed playlist may be stored locally on the one or more client devices 102-106. In this local storage implementation, the playlist data structure may be persisted in the device's local storage subsystem, which may include flash memory, solid-state storage, or other non-volatile storage media accessible to the application 302. During playlist creation method 400, the application 302 retrieves multimedia files from local device storage, database 714, and third-party platform 712. As users select files in step 404 and configure durations in step 406, the application 302 constructs a playlist data structure containing file references, metadata, display durations, and sequencing parameters rather than duplicating actual multimedia files. Upon publication in step 408, this playlist data structure is stored locally on client device 102-106. When accessed later, the application 302 reads the playlist data structure, resolves file references, and assembles the complete playlist for transmission to external device 708 or editing. In this local storage embodiment, the playlist remains accessible even when network connectivity is unavailable, enabling offline playlist management and reducing dependency on server availability.

In another embodiment, the completed playlist may be stored server-side on the server 704 or within the database 714 accessible through the server 704. In this server-side storage implementation, the playlist creation process may involve bidirectional communication between the client device 102-106 and the server 704 throughout the playlist creation method 400.

In this server-side storage embodiment, when the user selects multimedia files in step 404, the application 302 retrieves content from the database 714, third-party platform 712, and client device 102-106. The application 302 transmits selection data to the server 704, which constructs the playlist data structure by aggregating content references and storing metadata including display durations and sequencing information. Upon publication in step 408, the server 704 commits the playlist to persistent storage in the database 714. When accessed later, the application 302 requests the playlist from the server 704, which retrieves the data structure from the database 714 and transmits it to the client device 102-106 for rendering or editing

In this server-side storage embodiment, playlists may be accessible from multiple client devices 102-106, enabling users to manage their content across different devices and locations, and facilitating centralized backup and synchronization of playlist data across the user's retail network.

In an embodiment, the method 400 may be further comprised of a fifth step 410, wherein the one or more playlists 312 are transmitted, to an external device (described in more detail below) via wireless communication from the one or more client devices 102-106. In an embodiment, the one or more playlists 312 may be transmitted to any number or combination of the stores comprising the one or more stores 310. Additionally, the one or more playlists 312 may be transmitted to one or more external devices to be displayed simultaneously. The wireless communication between the one or more client devices 102-106 and the external device may be facilitated via Bluetooth. However, any suitable radio connection alternative may be employed to enable wireless communication between the one or more client devices 102-106 and the external device. An existing communication protocol may already be established between the client devices 102-106 and the external device, such as a wired connection, a wireless Internet-based connection, Bluetooth, or any other standard networking interface. Accordingly, communication stemming from the application 302 may leverage one of these preexisting modes of network communication, utilizing the underlying protocol stack without requiring additional physical infrastructure.

In a sixth step 412, the one or more playlists 306 may be displayed, via a display of the external device. The display may be a billboard-style device, a computer or television-style monitor, or any other hardware capable of displaying visual content. In various embodiments, the display device may further provide audio output capabilities, enabling the presentation of images, audio, or a combination thereof.

As mentioned above, the system 300 may further include an external device. The external device may be comprised of at least one of a data processing unit and the display. In an embodiment, the one or more client devices 102-106 may be configured to connect, via wireless communication, with the data processing unit. In such an embodiment, the one or more client devices 102-106 may transmit information to the external device, such that the external device may display said information via its display.

The system 300 may be configured to facilitate automated advertisement generation through integration with enterprise resource planning systems. In an embodiment, the system 300 may establish bidirectional communication protocols with the user's point-of-sale (POS) infrastructure and inventory management systems via application programming interfaces (APIs). Through such integration, the system 300 may execute algorithmic analysis of transactional data and inventory turnover metrics to identify underperforming product categories or specific stock keeping units (SKUs). The system 300 may implement machine learning algorithms to analyze sales velocity, inventory aging, and demand forecasting parameters to detect products exhibiting suboptimal performance characteristics. Upon identification of products with declining sales trajectories or excessive inventory dwell time, the system 300 may generate automated notifications to the user interface, providing data-driven recommendations for targeted advertisement creation. The recommendation engine may prioritize products based on configurable business rules, including profit margins, inventory carrying costs, expiration dates, and seasonal demand patterns, thereby enabling strategic promotional campaigns designed to optimize inventory turnover and revenue generation.

To create the one or more advertisements, the user may access the one or more advertisement templates, wherein said templates provide an outline for the user to quickly create the advertisements. For example, the user may select a template suitable to advertise a particular product. In an additional embodiment, the user may create individualized templates to suit said user's specific needs. The system 300 may be configured to generate custom templates, allowing the user to select and arrange the individual components (e.g., text position, duration of scenes, placement of images, etc.) that comprise the given template. Once created, the custom template may be saved and automatically populated with data corresponding to a selected item, ensuring consistent structure and output formatting. The custom template may also be stored for later use, enabling the user to apply it to different items without reconstructing the template each time.

Furthermore, after selecting the template, the user may scan, via the one or more client devices 102-106, a UPC barcode of the one or more products. In an embodiment, the UPC barcode may represent a series of numeric values corresponding to a specific product within the user's inventory. In such an example, the system 300 interacts with the POS and/or inventory management systems to identify the particular product the series of numeric values corresponds to.

The system 300 may then access an external database to retrieve one or more stock images corresponding to the scanned product. In an embodiment, said database stores one or more stock images for a plurality of products. For example, the external database may be stored on a cloud computing platform (e.g., Amazon Web Services). As a further illustration, upon scanning the UPC barcode for a particular product, the system 300 may then access the external database to facilitate user retrieval of one or more stock images corresponding to the scanned product. Subsequent to user retrieval, the one or more stock images may be imported into the user selected advertisement template.

The product image (or stock image) may exist in an unedited form with background elements from the original photography setting, or an edited form with the background removed to isolate the product against a transparent background layer. The edited form may be overlaid within the advertisement template, creating seamless visual integration wherein the product appears as an intentional design element rather than displaying incongruous background elements that detract from the template's aesthetic coherence. The system 300 may automatically remove backgrounds through image processing algorithms that detect product boundaries, or may receive edited images from administrators or users who upload pre-processed imagery, wherein the edited form is stored in the database 714 for template integration during advertisement creation.

After retrieving and importing the one or more stock images into the template, the system 300 may enable the user to edit said template prior to publication of its corresponding advertisement. Meaning, the user may further customize the template prior to finalization, which provides the user with greater customizability of advertisements prior to publication.

In a further embodiment, after a user has edited the template, an advertisement may be created, wherein said advertisement may be published to one of the various components comprising the user interface of the application 302. After the advertisement's publication, the user may then export and transmit said advertisement to the external device for display.

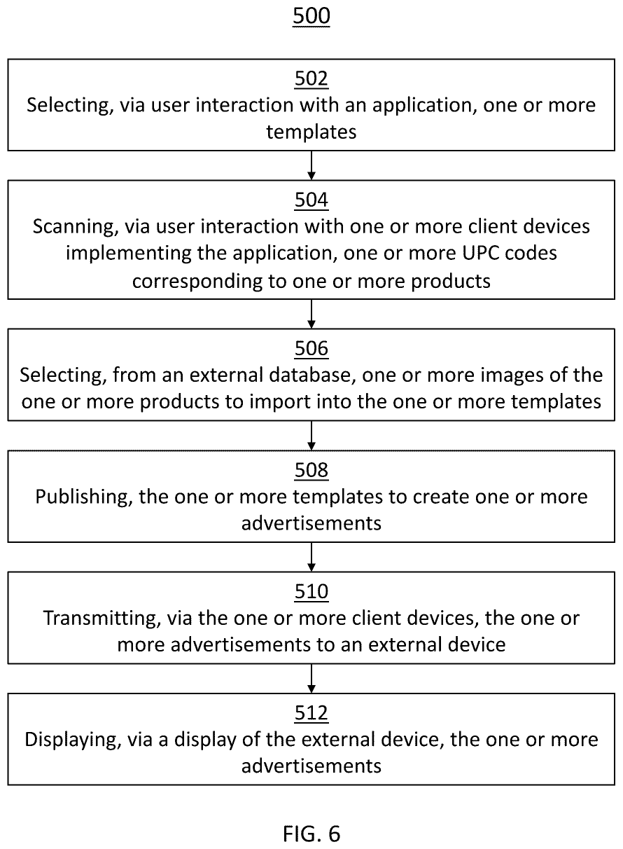

Moving on to FIG. 6, the present disclosure may also relate to the method for remote creation of dynamic advertisements (the “method”) 500.

In an embodiment, the method 500 may be comprised of at least a first step 502, wherein the user may select one or more advertisement templates stored within the application 302. The one or more advertisement templates may include configurable components such as image placement coordinates, background imagery or color schemes, text field positions for titles and pricing information, transition effects between content elements, and display duration parameters for individual scenes or frames. The templates may further define animation sequences, font styles and sizes, overlay graphics, product marker locations, and timing specifications that govern how content elements appear and transition during the advertisement playback cycle. In an embodiment, each of the one or more advertisement templates may be defined by a thematic design framework, wherein the templates may be categorized according to specific themes such as holiday celebrations, nautical motifs, party atmospheres, seasonal occasions, cultural events, or lifestyle concepts, thereby enabling users to select templates that align with their promotional messaging and target audience preferences.

In an embodiment, the one or more templates may be stored within the application 302 and accessed via user interaction with the application 302 and/or the navigation toolbar 308. Meaning, the user may access said templates via interaction with the application 302 and/or the navigation toolbar 308.

In a second step 504, the user may scan one or more products into the application 302. To illustrate, the application may integrate with the one or more client devices 102-106, such that the application 302 is able to access a camera of said devices 102-106, thus enabling the user to scan one or more products through the application 302. In an embodiment, the user may scan the UPC barcode of the one or more products as described above.

The method 500 may be further comprised of a third step 506, wherein the user selects one or more images of the scanned product to import into the one or more templates. For example, after scanning the UPC barcode of a particular product, the user may be directed to the external database, which stores one or more stock images for the scanned product. Thus, the user is able to navigate the external database to find one or more stock images suitable for the advertisement said user is creating. In an embodiment the user may select two or more images of the product they are creating an advertisement for. Furthermore, the user may edit the selected advertisement template. As a nonlimiting example, after the user has imported the desired stock images into the template, the user may reconfigure said images prior to publishing the template as a finalized advertisement. In such an example, the user is able to better customize advertisements to suit their needs and to attract customers.

In an embodiment, users may create one or more advertisements and upload them to one of the various components comprising the application 302. For instance, the one or more advertisements may be uploaded to a “my ads” component. Moreover, the user may display their uploaded advertisements on the display of one or more external devices.

Furthermore, there may be at least two types of playlists. In one embodiment, there may be a default playlist where the user selects a template and may subsequently select a plurality of products they wish to advertise. As an illustration the plurality of products may be comprised of up to eight products. After the products have been selected, the application 302 may create the one or more advertisements by adding the stock image of a particular product to the template. For example, the application 302 may create up to eight advertisements in no more than seven and a half seconds. In such an example, the application 302 may render a playlist with a duration of one minute to display the eight advertisements.

Moreover, there may be a second type of playlist. In an embodiment, the user may select one or more images from one of the various components comprising the application 302. For instance, the stock images may be selected from the “my ads” component. In such an embodiment, the one or more advertisements may be created via utilization of a template, wherein the user adds a product to said template, and saves to one of the various components comprising the application 302. Moreover, the stock images may be uploaded from external sources.

In a fourth step 508 of the method 500, the user may publish the template to create an advertisement. In an embodiment, the advertisement may be published to one of the various components comprising the user interface of the application 302. In such an embodiment, the user may access the published advertisement at any point in time after creation.

In yet a further embodiment, the method 500 may be comprised of a fifth step. In said fifth step 510, the user may transmit the advertisement to the external device. As described above, the external device may be comprised of the data processing unit and the display. For example, the data processing unit may enable the one or more client devices 102-106 to connect with the external device, via wireless communication. Thus, the one or more client devices 102-106 may transmit information to the external device, enabling the external device to display said information via its display.

In a sixth step 512 of the method 500, after the user has transmitted the advertisement to the external device, the user may display said advertisement upon the external device, via its display. In an embodiment, the user may choose a duration to display the advertisement. Moreover, the user may display the advertisement in the one or more playlists 306 as described above. For instance, the user may create a series of advertisements in a single playlist. Thus, the user may display multiple advertisements on the external device via the one or more playlists 306.

Finally, other implementations of the disclosure will be apparent to those skilled in the art from consideration of the specification and practice of the disclosure disclosed herein. It is intended that the specification and examples be considered as exemplary only, with a true scope and spirit of the disclosure being indicated by the following claims.

Referring to FIG. 7, a system 700 may include a client device 702, a server 704, a product 706, an external device 708 comprising a display 716, a third-party platform 712, and/or a database 714. For the purposes of this disclosure, the architecture, structure, and function of client device 702 and server 704 may include and/or embody any of the features or elements of client devices 102-106 and servers 107-109, respectively. Further, while the database 714 may be depicted as a separable element in FIG. 7, it is contemplated that the database 714 may be housed on the server 704 and/or may be a distinct component, retrievable via the server 704. While FIG. 7 and the description herein refers to a “third-party” platform 712, it is understood that the function and features of the third-party platform 712 may also be carried out by the server 704, the client device 702, the database 714, or another component of the system. In effect, while many embodiments contemplate integration with third-party platforms (e.g., distinct POS or inventory management systems), it is also contemplated that such functionalities may be intrinsic to the system core infrastructure. Yet further, while FIG. 7 and parts of the description herein depict the server 704 providing middleman communication between the database 714 and the client device 702 and the third-party system 712 and the client device 702, it is understood that in some embodiments the client device 702 may communicate directly with the database 714 and/or the third-party platform 712.

The system 700 and its components may embody or utilize the components described in FIG. 1 and FIG. 2, wherein the client device 702 may incorporate the electronic device 200 architecture including the CPU 202, memory 230, network interface 214, and I/O interface 240, and wherein the server 704 may similarly implement the electronic device 200 structure to facilitate processing, storage, and communication functions. The system 700 may leverage the network infrastructure illustrated in FIG. 1, including the wireless network 110 and wide area network 112, to enable communication between the client device 702, server 704, third-party platform 712, database 714, and external device 708.

The client device 702 may be a smart phone or other computerized device, for example, utilized by a user seeking to display content on the external device 708. The external device 708 may be a commercial-grade digital display screen or television monitor specifically configured for storefront window installation, wherein the external device 708 serves as a dynamic advertising platform capable of presenting visual content to pedestrians and potential customers passing by the retail establishment. The external device 708 includes the display 716 and associated processing hardware that enables reception, processing, and presentation of digital content transmitted from remote sources. The primary function of the external device 708 is to display advertisements, promotional content, and multimedia presentations that have been created and configured through the application 302 running on the client device 702. The external device 708 maintains bidirectional communication with both the client device 702 and the server 704 through wireless communication protocols such as Bluetooth, Wi-Fi, or other suitable networking technologies, enabling real-time content updates and remote management capabilities. When a user interacts with the application 302 on the client device 702 to create advertisements, select playlists, or modify display settings, these inputs are processed and transmitted to the external device 708, which responds by updating its displayed content accordingly. The external device 708 can be remotely controlled and manipulated through user inputs to the application 302, allowing store owners to change promotional content, adjust display schedules, activate or deactivate specific advertisements, and manage multiple screens across different store locations without requiring physical access to the display hardware.

The database 714 may store product information including UPC codes, product names, descriptions, pricing data, inventory levels, and associated multimedia content such as stock images and promotional videos for a plurality of products available in the retail beverage industry. The data may be populated through multiple channels, including bulk imports from manufacturers and distributors, automated data feeds from third-party platforms 712 such as POS or inventory management systems, manual entry by system administrators, and user-generated uploads that undergo verification processes before inclusion. The database 714 may organize data using relational database structures with indexed fields such as UPC codes, product categories, brand names, and SKU numbers to facilitate efficient retrieval and searching. When a user scans a UPC barcode via the client device 702 or performs a manual product search, the system 700 may query the database 714 using the scanned identifier or search parameters, wherein the database 714 returns matching product records along with associated metadata and multimedia assets that can be integrated into advertisement templates.

The product 706 may be a physical retail item, such as a bottle of wine, spirits, beer, or other beverage product, that is available for sale at a retail establishment and is intended to be featured in advertisements created through the system 700. The product 706 may include a scannable identifier, such as a UPC barcode, RFID tag, or other machine-readable code, that enables the client device 702 to capture product identification information and retrieve corresponding data from the database 714. In some cases, the product 706 may have associated digital records stored in the database 714 or accessible through the third-party platform 712, including product imagery, pricing information, descriptive text, and inventory status, which can be utilized by the system 700 to generate advertisements featuring the product 706.

The third-party platform 712 may provide an API that enables the system 700 to access data stored on external systems such as inventory management systems, POS systems, or product catalog platforms. When the system 700 interfaces with the third-party platform 712, it may authenticate using the user's credentials to retrieve data specific to that user's retail operations, including current inventory levels, product pricing, sales history, and product availability. The retrieved data may be used to populate the database 714 with information relevant to the user's specific inventory, ensuring that the application 302 reflects accurate and up-to-date product information for advertisement creation. In some embodiments, the data obtained from the third-party platform 712 may be stored persistently in the database 714 for ongoing access and reference, while in other embodiments the data may be retrieved on-demand and temporarily imported to the server 704 for immediate use within the application 302 without permanent storage in the database 714. This flexible data integration approach allows the system 700 to maintain synchronization with the user's existing business systems while accommodating different data management preferences and operational requirements.

The interfaces described herein represent nonlimiting embodiments of the system 700, and it is understood that the features, components, and functionality demonstrated through these interfaces may be implemented through alternative interfaces, backend processes, automated workflows, or other technical mechanisms without requiring direct user interaction with the specific interfaces shown. Additionally, features, components, and functionality shown in one interface may be incorporated into, combined with, or adapted for use in other interfaces within the system 700, allowing for flexible implementation and customization of the user experience across different interface configurations.

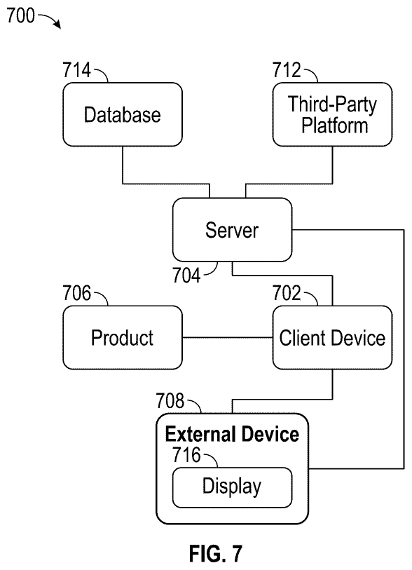

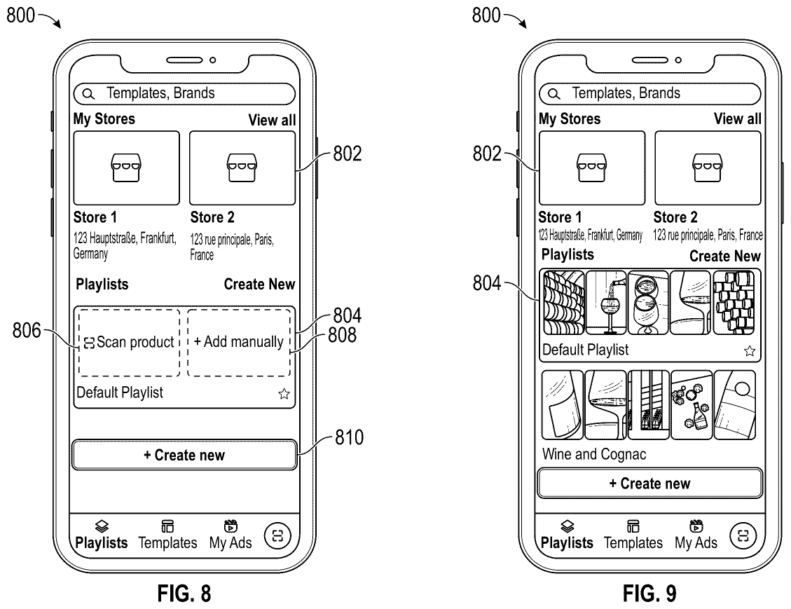

FIG. 8 illustrates an embodiment of a main playlist interface 800. The main playlist interface 800 may include a store panel 802, a playlist panel 804, a scan product button 806, a manual product entry button 808, and a new playlist button 810. The store panel 802 displays each of the stores associated with a given user, wherein these stores are saved in the database and are reflective of a physical location, such as a liquor store, however they can also be representative of a digital storefront. As described above, the system may be configured to receive, from the user, one or more locations corresponding to one or more storefronts owned by the user, which are then displayed as the one or more user stores in the stores panel 304. The store panel 802 thus provides a centralized interface for users to manage multiple retail locations within the application 302, enabling efficient oversight of their entire network of stores from a single dashboard.

The playlist panel 804 displays the playlists associated with a given user, for example these are playlists that have been curated by the user. The playlist panel 804 serves as a centralized navigation hub, allowing users to efficiently access and manage their collection of advertisement playlists from a single interface location. By providing direct access to previously created playlists, the playlist panel 804 enables users to quickly select, modify, or deploy existing content without having to recreate advertisements, thereby streamlining the workflow for managing dynamic advertisement campaigns across multiple store locations.

The scan product button 806 is an interactive button on the interface that instructs the device to seek an image, for example a UPC code or an image (photograph) of the product, wherein a user may click the scan product button 806 to capture an image of a product or the product's UPC code or another identifying scannable element. This scanning functionality is important for enabling rapid product identification and advertisement creation, as it eliminates the need for manual product entry and significantly reduces the time required to generate promotional content. The system may generate an intuitive scanning interface that provides visual guidance to users, including scanning frame overlays and real-time feedback to ensure proper alignment and capture of the product or barcode. By simply pointing their device's camera at a product or its UPC code, users can instantly access product information from the external database and seamlessly integrate it into their selected advertisement templates, streamlining the entire workflow from product identification to advertisement deployment.

Upon scanning a UPC code or similar scannable element, the system may query the central database to identify a matching product entry, wherein the database may return associated product details including wholesale cost, retail price, product title, product description, and other relevant metadata. This automated retrieval process may enable the application to populate advertisement templates with accurate product information without requiring manual data entry by the user.

In some embodiments, the system may incorporate image recognition or optical character recognition (OCR) technology to analyze captured images of products and identify corresponding entries within the product database. The image recognition functionality may process visual characteristics of the product, such as label design, bottle shape, or brand logos, and compare these features against stored reference images in the database to determine a match. When a product image is captured without a visible UPC code, the OCR technology may extract text from the product label, such as brand names, product names, or vintage information, and use this extracted text to search the database for matching product records.

The manual product entry button 808 is an interactive button that provides users with an alternative method for product identification when barcode scanning is not feasible or preferred, enabling comprehensive product searches through multiple search parameters including product names, brand identifiers, category classifications, price ranges, and other descriptive attributes. This manual search functionality accesses the comprehensive product database to retrieve matching results based on user-specified criteria, allowing users to browse, filter, and select products for advertisement creation without requiring physical access to the product or its UPC barcode.

The new playlist button 810, upon selection, allows the user to create a new playlist. This action initiates the playlist creation workflow described in method 400, beginning with step 402 where the user is prompted to name the new playlist before proceeding through the subsequent steps of multimedia file selection, duration configuration, and publication.

FIG. 9 illustrates another view of an embodiment of the main playlist interface 800, specifically showing the playlist panel 804 populated with multiple playlists associated with the user. In this view, the playlist panel 804 may display a collection of user-created playlists, which may include a default playlist and specialized playlists such as wine and cognac playlists. For enhanced user navigation and identification, each playlist displayed within the playlist panel 804 may include visual previews or thumbnails representing the content contained within the playlist, along with the descriptive title of the respective playlist. This visual organization may enable users to quickly identify and select the appropriate playlist for their advertising needs, streamlining the content management workflow within the application.

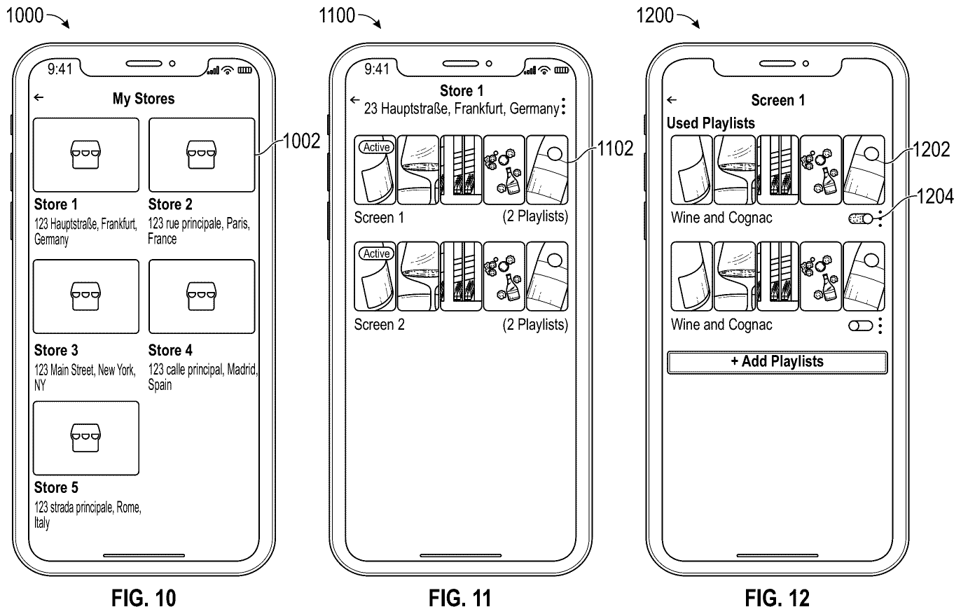

FIG. 10 illustrates an embodiment of a main stores interface 1000 that may display one or more selectable store buttons 1002 representing different store locations for managing multiple retail establishments. Each store button 1002 may correspond to one of the stores associated with the user, wherein the store data may be retrievable from the database 714. Selection of a store button 1002 may generate and display the specific store interface 1100, enabling users to navigate from the main stores interface 1000 to detailed management views for individual store locations within their retail network.

FIG. 11 illustrates an embodiment of a specific store interface 1100 that may include one or more screen panels 1102 corresponding to individual display screens at a selected store location. Selection of a store button 1002 in the main stores interface 1000 may cause the generation and display of the specific store interface 1100 associated with the selected store 1002. The specific store interface 1100 may serve as a management hub that enables users to monitor and control multiple display screens within a single retail location from a centralized interface. Each screen panel 1102 may be selectable and interactive, wherein selection of a screen panel 1102 may generate and display the screen-playlist interface 1200, allowing users to manage content and playlists for individual screens. In some embodiments, each screen panel 1102 may display real-time status information indicating whether the corresponding display screen is active or inactive. An active status may indicate that there is a valid and strong network connection between the system and the display device, confirming that the screen is powered on and successfully receiving content transmissions. Conversely, an inactive status may indicate that there is a poor signal quality, network connectivity issues, or that the display device is not powered on or otherwise unable to maintain network connection with the system. This activity indicator functionality may provide users with remote visibility into the actual presentation status of each screen, enabling them to verify that their content is being actively displayed despite not being physically present at the store location. This remote monitoring capability may ensure that the technology not only successfully broadcasts playlists and advertisements as intended, but also provides users with real-time insight into the operational status of their digital signage network, facilitating proactive troubleshooting and content management across multiple retail locations.

FIG. 12 illustrates an embodiment of a screen-playlist interface 1200 that may include one or more used playlist panels 1202 and a display toggle 1204 for activating content display on the associated screen. The screen-playlist interface 1200 may be utilized to show which playlists are available to a given screen, wherein the playlists may be demonstrated as used playlist panels 1202. Each used playlist panel 1202 may include a display toggle 1204, wherein the display toggle 1204 may be toggled to activate or deactivate a playlist on the given screen. Accordingly, the screen may cycle through playlists that are toggled on and may skip playlists that are toggled off. In one embodiment, a screen may present a single playlist, in which case only one playlist may be selectable via display toggle 1204 at a time. However, in another embodiment, the screen may showcase a plurality of playlists where the screen may show all playlists toggled in the on position. The playlists may be ranked or prioritized in order of appearance by manipulating the position of used playlist panels 1202 within the screen-playlist interface 1200.

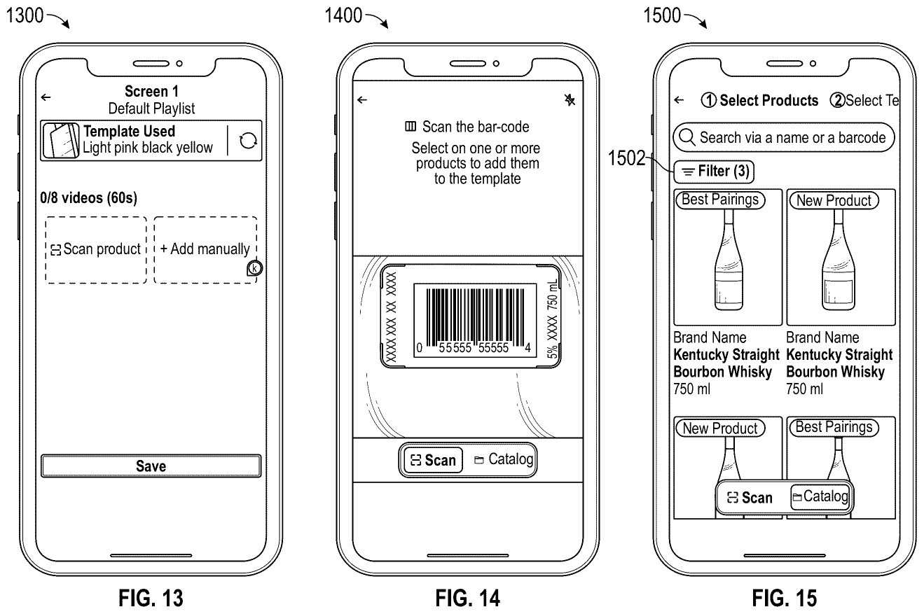

FIG. 13 illustrates an embodiment of a default template interface 1300 that may be generated after accessing the default playlist associated with a given screen. At the default template interface 1300, the system may seek input on a number of products either by scanning UPC codes or by manual product entry, as described elsewhere herein. The system may throttle the number of videos allowed in a given playlist based on the playlist parameters. For example, a playlist may be configured for 8 videos, with each video associated with a different product. In other embodiments, the playlist may be configured for 8 videos where the videos may be for the same product or a combination of products. In yet other embodiments, the default playlist may have any suitable number of videos listed as a limit. The number of videos or runtime of the playlist may be a function of the playlist parameters such as the content of the playlist, the transitions between videos, the runtime of a given slide or video within the playlist or advertisement, and other configurable elements that may affect the overall presentation duration and structure.

FIG. 14 illustrates an embodiment of a scanner interface 1400 that may provide barcode scanning functionality with visual guidance for proper product identification. The scanner interface 1400 may include a guide element that indicates where a UPC code or other scannable element should be positioned relative to the device's camera to properly capture the scannable element, ensuring accurate scanning and product recognition. The scanner interface 1400 may display a scanning frame overlaid on the camera view, providing real-time visual feedback to users for optimal alignment of the product or barcode within the scanning area. Additionally, the scanner interface 1400 may include an option to switch to catalog search mode, enabling users to transition from barcode scanning to manual product search functionality, for example as demonstrated with the product search interface 1500, thereby providing alternative methods for product identification when scanning is not feasible or preferred.

FIG. 15 illustrates an embodiment of a product search interface 1500 that may present a comprehensive product selection and filtering system. The product search interface 1500 may include a filter selector 1502 positioned at the top of the interface, wherein the filter selector 1502 may offer a plurality of filtering options to refine product search results. The available filter options may include category filters such as wine, spirits, beer, and non-alcoholic beverages; brand filters enabling selection by manufacturer or distributor; price range filters allowing users to specify minimum and maximum price thresholds; alcohol content filters for beverages containing alcohol; vintage year filters for wine and aged spirits; region or country of origin filters; size or volume filters such as 750 ml, 1 L, or other container sizes; availability status filters indicating in-stock versus out-of-stock items; promotional status filters for items on sale or special promotion; and rating filters based on customer reviews or expert scores. The product search interface 1500 may further include a plurality of product icons displayed below the filter selector 1502, wherein each product icon may correspond to a product stored in the database and may be dynamically filtered based on the selected filter criteria. Each product icon may include an informative overlay that provides additional product information derived from the database, such as “Best Seller” indicators for high-performing products, “New Product” labels for recently added inventory items, “On Sale” notifications for discounted products, “Limited Edition” markers for exclusive items, “Staff Pick” recommendations, or “Low Stock” warnings for items with limited availability. These informative overlays may be populated automatically based on real-time data stored in the database, including sales performance metrics, inventory levels, product introduction dates, and promotional status. Accordingly, users may quickly identify which products are new arrivals, best-selling items, or currently featured in promotional campaigns directly from the product search interface 1500, enabling informed product selection for advertisement creation without requiring additional navigation or data lookup.

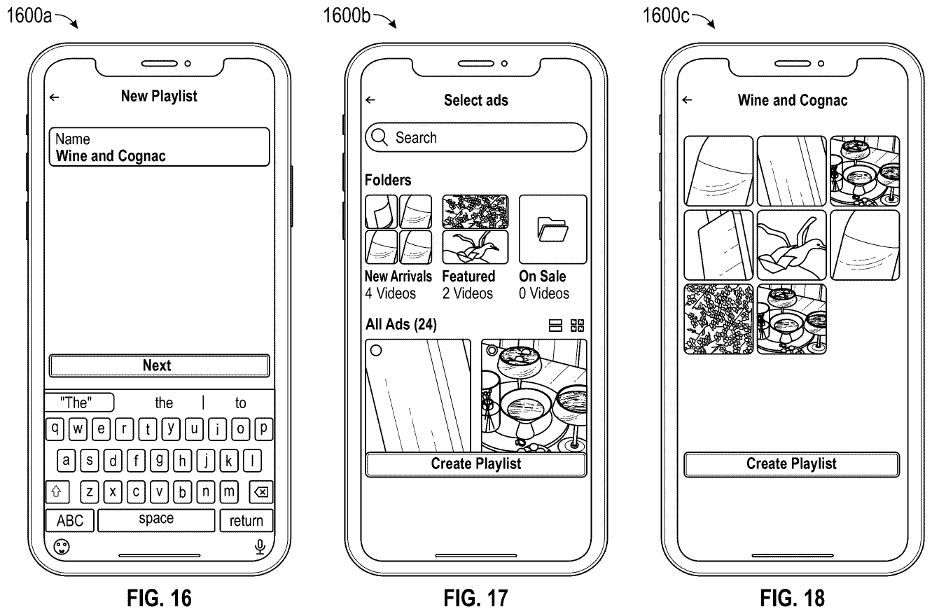

FIGS. 16-21 illustrate an embodiment of a new playlist creation workflow across a number of sequential interfaces 1600a-1600f, including but not limited to playlist naming, content selection, ordering, and confirmation steps.

FIG. 16 illustrates the new playlist interface 1600a, which may initiate the playlist creation workflow by prompting the user to input a name for the new playlist, establishing the foundational identifier for the content collection.

FIG. 17 depicts the select ads interface 1600b, which may enable users to browse and select from available advertisements, multimedia files, or other content elements to populate the newly named playlist. The select ads interface 1600b may present a comprehensive selection environment where users can navigate through various content categories, which may include previously created advertisements stored in the application, multimedia files accessible from the client device's local storage, and content available through integrated third-party platforms. Users may employ filtering and search functionality to locate specific content types, apply selection criteria based on product categories or promotional themes, and preview content elements before adding them to the playlist. The selection process may allow for multiple content items to be chosen simultaneously, with visual indicators showing which items have been selected for inclusion in the playlist. Once the desired content elements are identified and selected, users may proceed to the next stage of the playlist creation workflow, where the selected items may be arranged and configured for display sequencing.

FIG. 18 shows the new playlist interface 1600c, which may display the selected content items and may provide options for reviewing or modifying the initial selections before proceeding to arrangement.

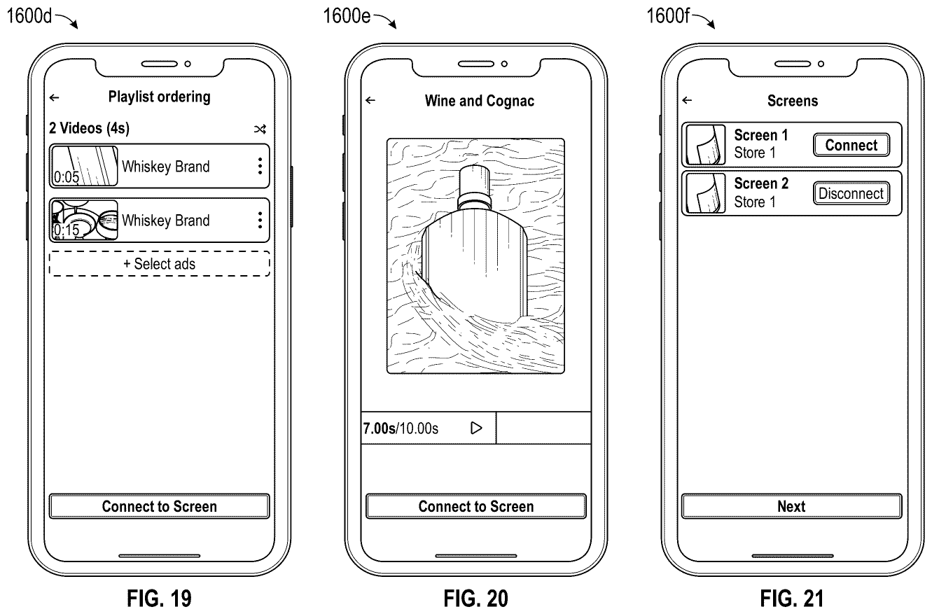

FIG. 19 illustrates the playlist ordering interface 1600d, which may allow users to arrange the selected content items in a desired sequence by reordering the elements to control the playback flow of the playlist. The ordering mechanism may enable users to drag and drop content items within the interface, repositioning advertisements, multimedia files, and other content elements to achieve optimal presentation timing and customer engagement. The sequence established through the playlist ordering interface 1600d may directly impact the final displayed product by determining the chronological flow of content presentation on the external device display, influencing customer viewing patterns and promotional effectiveness. For example, high-priority promotional content may be positioned at the beginning of the playlist sequence to capture immediate attention, while complementary content such as cocktail recipes or lifestyle imagery may be strategically placed between product advertisements to maintain viewer engagement throughout the entire playlist duration. In an embodiment, the playlist may be ordered automatically based on predefined criteria such as product priority rankings, seasonal relevance, inventory levels, or promotional campaign schedules, wherein the system may automatically arrange content items according to algorithmic optimization without requiring manual user intervention. In another embodiment, the playlist ordering interface 1600d may include a shuffle mode option selectable by the user, wherein the playlist content may be randomized during playback to provide varied viewing experiences and prevent predictable content patterns, thereby maintaining customer interest through dynamic presentation sequences that may change with each playlist cycle.

FIG. 20 depicts a playlist preview interface 1600e, which may allow the user to watch the playlist as a final confirmation step before finalization, wherein the user may review the complete playlist sequence and either return to make adjustments or proceed to complete the playlist creation process.

FIG. 21 shows the playlist confirmation interface 1600f, which may provide a final review of the configured playlist including the name, selected content, and playback order, allowing users to confirm and save the playlist or make final adjustments before completion of the creation process. At the playlist confirmation interface 1600f, the available screens may be displayed, enabling users to connect the selected playlist to a desired screen location within their store network. This screen selection functionality may allow users to immediately deploy their newly created playlist to specific display devices, providing direct control over which screens will showcase the configured content and ensuring that promotional materials reach the intended audience at the appropriate retail locations.

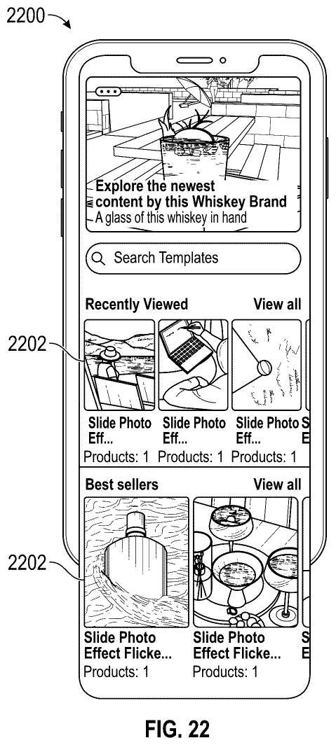

FIG. 22 illustrates an embodiment of a main template interface 2200 that may provide comprehensive template organization and selection capabilities for advertisement creation. The main template interface 2200 may include a plurality of template panels 2202, wherein each template panel 2202 may be directed to a specific category or curated list of templates designed to facilitate targeted promotional content creation. The template panels 2202 may include categories such as recently viewed templates, best sellers, new arrivals, on sale promotions, staff picks, branded content, holiday-themed templates, and product category-specific templates such as wine, spirits, beer, or seasonal beverages. Each template panel 2202 may display a collection of professionally designed advertisement templates that may be optimized for the respective category, enabling users to quickly identify and select templates that align with their promotional objectives. The template categories represented by the template panels 2202 may be dynamically updated by an administrator for the application, allowing for real-time curation of template collections based on seasonal trends, promotional campaigns, inventory priorities, or market conditions. This administrative control may ensure that the main template interface 2200 remains current and relevant, providing users with access to the most effective and timely template options for their advertisement creation needs.

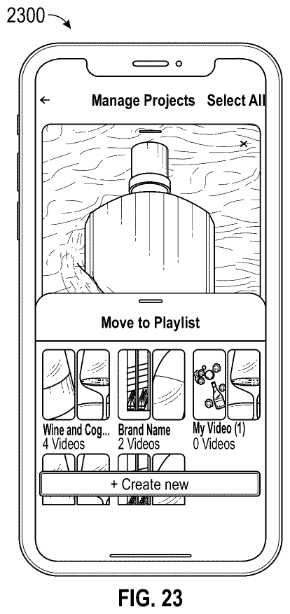

FIG. 23 illustrates an embodiment of a playlist-template addition interface 2300 that may enable users to transfer a selected template from the main template interface 2200 into a designated playlist. The playlist-template addition interface 2300 may provide functionality for users to select a target playlist from available playlists and confirm the addition of the chosen template to that playlist, thereby facilitating the integration of template-based content into organized playlist collections for subsequent display on external devices.

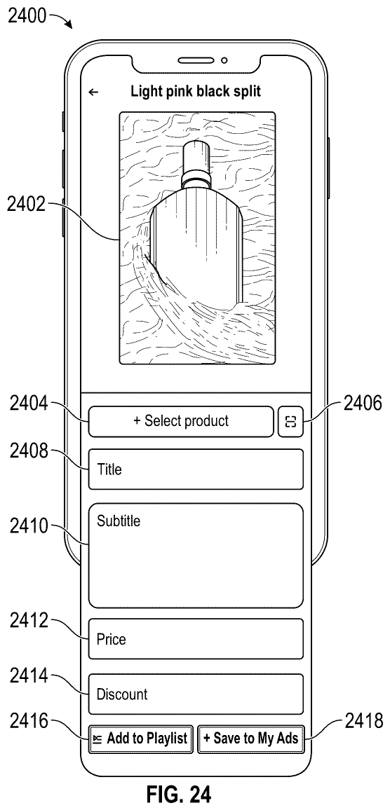

FIG. 24 illustrates an embodiment of an advertisement generation interface 2400 that may provide comprehensive functionality for creating single-product advertisements within the application. The advertisement generation interface 2400 may include a representative image 2402 that may display a visual representation of the selected product, enabling users to preview how the product will appear in the final advertisement. The interface may further include a manual product selection button 2404 that may allow users to browse and select products from the database through a search interface, and a scanner product selection button 2418 that may enable users to identify products by scanning UPC barcodes using the device's camera functionality.

For content customization, the advertisement generation interface 2400 may provide a title field 2406 where users can enter the primary headline text for the advertisement, and a subtitle field 2408 for additional descriptive information or promotional messaging. Pricing configuration may be facilitated through a price field 2410 that may allow users to specify the product's selling price, and a discount field 2412 where promotional discounts or special offers can be entered.

The title field 2406, subtitle field 2408, price field 2410, and discount field 2412 may be automatically populated with data retrieved from the database upon selection of a product through either the manual product selection button 2404 or the scanner product selection button 2418. When a product is identified and selected, the system may query the database to retrieve associated product information, including the product name, descriptive text, retail pricing, and any active promotional discounts, and may automatically populate the respective fields with this retrieved data. This autopopulation functionality may reduce manual data entry requirements and may ensure consistency between the database records and the displayed advertisement content, while still allowing users to manually edit or override the autopopulated values to customize the advertisement according to specific promotional objectives or messaging preferences.

In further embodiments, an AI assistant may be linked to each of the title field 2406, subtitle field 2408, price field 2410, and discount field 2412, wherein selection of the AI assistant may trigger automatic population of the respective field based on data retrieved from the database and based on a trained model that has been trained on advertisement content of similar types. The trained model may analyze product attributes, historical promotional performance data, and successful advertisement patterns to generate optimized field content that may enhance promotional effectiveness and customer engagement.

Each field within the advertisement generation interface 2400 may correspond to a designated display element within the selected advertisement template, wherein the values entered or autopopulated in these fields may be mapped to specific visual or textual representations in the final rendered advertisement. The title field 2406 may map to a primary headline text element positioned prominently within the template layout, the subtitle field 2408 may correspond to a secondary descriptive text area, the price field 2410 may be represented as a formatted price display with currency symbols and numerical formatting, and the discount field 2412 may be visualized as a promotional badge, percentage indicator, or strikethrough pricing element. When the advertisement is generated and added to a playlist for display, the template rendering engine may process these field values and may insert them into their corresponding template positions, ensuring that the user-configured content appears in the appropriate locations within the final advertisement as displayed on the external device.

Upon completion of the advertisement creation process, users may utilize a playlist addition button 2414 to directly add the generated advertisement to an existing playlist for immediate deployment, or alternatively may use an advertisement archive button 2416 to save the completed advertisement to their personal advertisement library for future use and organization.

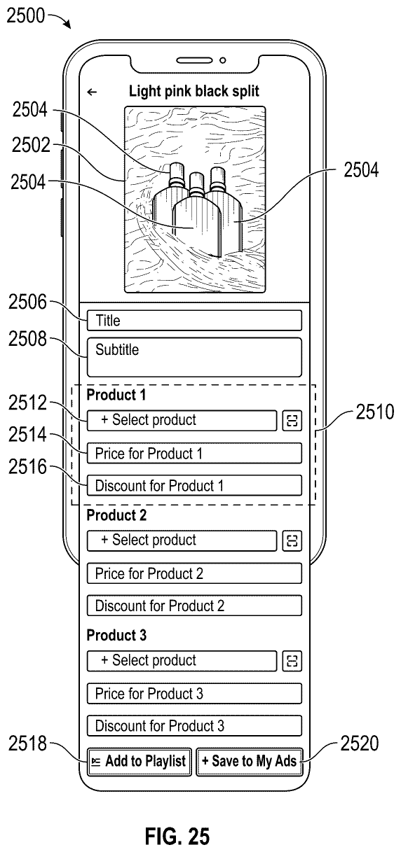

FIG. 25 illustrates an embodiment of a multi-product advertisement generation interface 2500 that provides comprehensive functionality for creating advertisements featuring multiple products within a single promotional display. The multi-product advertisement generation interface 2500 includes a representative image 2502 that displays a visual preview of how the final advertisement will appear, enabling users to see the complete multi-product layout before publication. The representative image 2502 includes one or more product markers 2504 that are strategically positioned within the image to indicate the location and identification of each product featured in the advertisement. Each product marker 2504 corresponds to a specific product selected through the interface and serves as a visual identifier that will be visible in the final rendered advertisement, thereby optimizing the display by clearly labeling and distinguishing multiple products within a single promotional frame.

For overall advertisement customization, the multi-product advertisement generation interface 2500 provides a master title field 2506 where users can enter the primary headline text that will apply to the entire multi-product advertisement, and a master subtitle field 2508 for additional descriptive information or promotional messaging that encompasses all featured products. The interface further includes one or more product modules 2510, wherein each product module 2510 pertains to a specific individual product that will be included in the multi-product advertisement. This modular approach enables the multi-product advertisement generation interface 2500 to accommodate the inclusion of various products within the same advertisement, allowing retailers to create comprehensive promotional displays that showcase multiple related items, complementary products, or bundled offerings within a single cohesive advertisement framework.

Each of the one or more product modules 2510 includes a product selection button 2512 that allows users to browse and select a specific product from the database for inclusion in that particular module position, a price field 2514 where users can specify the selling price for the individual product associated with that module, and a discount field 2516 where promotional discounts or special offers can be entered for the specific product. The mapping relationship between each product module 2510 and its corresponding product marker 2504 in the representative image 2502 ensures that the final advertisement accurately reflects the product selections and pricing information configured through the interface. When the multi-product advertisement is generated and displayed, each product marker 2504 visible in the final advertisement corresponds directly to the product information entered in its associated product module 2510, creating a clear visual connection between the products shown in the advertisement and their respective pricing and promotional details.

Upon completion of the multi-product advertisement creation process, users can utilize a playlist addition button 2518 to directly add the generated multi-product advertisement to an existing playlist for immediate deployment across multiple display screens, or alternatively use an advertisement archive button 2520 to save the completed multi-product advertisement to their personal advertisement library for future use and organization. The presence of visible product markers 2504 in the final advertisement optimizes the display effectiveness by providing clear product identification and organization within the single promotional frame, enabling customers to easily distinguish between different products while maintaining visual coherence and promotional impact across the entire multi-product presentation.

The multi-product advertisement generation interface 2500 may be configured to present only those templates that are specifically designed to accommodate multiple products within a single advertisement frame. In such embodiments, the system may filter the available template options based on the multi-product capability of each template, wherein templates lacking support for multiple product placements may be excluded from selection when a user initiates creation of a multi-product advertisement. Conversely, when a user accesses the single-product advertisement generation interface 2400, the system may present templates optimized for single-product displays, which may feature larger product imagery, simplified layouts, or design elements that emphasize a single focal point. This template filtering functionality ensures that users are presented with appropriate design options that match their intended advertisement structure, preventing selection of incompatible templates that cannot properly accommodate the desired number of products. The system may determine template compatibility by analyzing template metadata stored in the database, wherein each template may be associated with attributes indicating the minimum and maximum number of products supported, the positioning coordinates for product markers 2504, and the layout constraints that define how multiple products can be arranged within the template framework. In some cases, certain templates may be versatile enough to support both single-product and multi-product configurations, wherein the template layout may dynamically adjust based on the number of products selected by the user, automatically repositioning design elements, adjusting text field sizes, or modifying the spatial arrangement of product imagery to optimize visual presentation regardless of whether one product or multiple products are featured in the final advertisement.

The database may be populated with product images through multiple importation pathways to ensure comprehensive product coverage and visual content availability. In some embodiments, images may be manually imported by system administrators who curate and upload product imagery to maintain quality standards and database consistency. Additionally, the system may be configured to automatically retrieve images from web-based sources, wherein image data is pulled from manufacturer websites, distributor catalogs, or other online repositories that provide product photography and visual assets. In further embodiments, manufacturers, wholesalers, distributors, and other supply chain entities may directly import images to the database or may facilitate the importation process by providing bulk image files, API access to their product catalogs, or automated data feeds that include visual content alongside product information. The system may also enable user-generated content submission, wherein users of the application may upload images of products to the database, and wherein such user-submitted images may undergo a verification or confirmation process by administrative personnel before being approved for inclusion in the database and made available for use in advertisement creation. This verification process may ensure that user-submitted images meet quality standards, accurately represent the associated products, and comply with applicable content guidelines. While the term “image” is used throughout this disclosure for convenience, it should be understood that “image” may encompass any multimedia file format, including but not limited to static image files such as JPEG, PNG, or GIF formats, as well as dynamic multimedia content such as video files in MP4, MOV, AVI, or other video formats, animated graphics, and any other visual or audiovisual content suitable for display within advertisement templates and on external display devices.

While the specification describes the system in the context of liquor stores and beverage retail environments, the underlying system architecture and functionality may be adapted and configured for any retail business that includes a storefront window and display elements. The system's core capabilities—including template-based advertisement creation, product scanning and identification, remote content management, playlist scheduling, and window-facing digital signage—may be applied across diverse retail sectors where visual merchandising and customer engagement are priorities. The system may be deployed in various retail environments, including but not limited to: clothing and apparel stores, jewelry stores, electronics retailers, sporting goods stores, bookstores, toy stores, home goods and furniture stores, cosmetics and beauty supply stores, pet supply stores, and specialty food retailers such as bakeries, cheese shops, or gourmet markets.

In one embodiment, the system may be configured for use in a clothing boutique or fashion retail environment. In such an implementation, the product scanning functionality may be adapted to recognize garment tags, SKU labels, or RFID tags associated with clothing items rather than UPC barcodes on bottles. The database may store product images showing clothing items on models or mannequins, along with associated metadata such as sizes available, color variations, fabric composition, and care instructions. The advertisement templates may be designed to showcase fashion items with seasonal styling suggestions, outfit combinations, or trend-focused messaging. For example, a boutique owner may scan a new arrival dress, select a template featuring a lifestyle background image, and quickly generate an advertisement displaying the dress with pricing information and a promotional message such as “New Spring Collection” or “Limited Sizes Available.” The multi-product advertisement generation interface may enable the creation of coordinated outfit displays, wherein multiple clothing items and accessories are featured together with individual product markers indicating each component of the ensemble. The playlist functionality may allow the boutique to schedule different content throughout the day, displaying professional workwear during morning commute hours, casual weekend styles during midday, and evening wear during afternoon and evening periods when customers may be shopping for special occasions.

In another embodiment, the system may be configured for use in an electronics retail store specializing in consumer technology products. In this configuration, the product identification functionality may recognize manufacturer part numbers, model numbers, or electronic article surveillance (EAS) tags associated with devices such as smartphones, tablets, laptops, headphones, or smart home devices. The database may store high-resolution product images, technical specifications, feature highlights, and comparison data for various electronic products. The advertisement templates may be designed to emphasize technical specifications, feature callouts, and competitive pricing, with visual elements such as specification tables, feature icons, or comparison charts integrated into the template designs. An electronics retailer may use the system to quickly create advertisements for newly released products, price reductions on previous-generation models, or bundle promotions combining complementary devices. For instance, when a new smartphone model is released, the store owner may scan the product, select a template designed for mobile device promotions, and generate an advertisement that displays the device image alongside key features such as camera specifications, battery life, display technology, and available storage options. The system may integrate with the store's inventory management system to automatically update advertisements when stock levels change, enabling the retailer to promote items that are overstocked or to create urgency messaging for limited-quantity items. The multi-product advertisement capability may be particularly valuable for creating bundle promotions, wherein a smartphone, protective case, screen protector, and wireless charger are displayed together with individual pricing and a total bundle price, encouraging customers to purchase complete accessory packages rather than individual items.

In a further embodiment, the system may be configured for use in a specialty food retail environment such as a gourmet cheese shop, artisanal bakery, or premium chocolate retailer. In such implementations, the product identification functionality may be adapted to recognize product labels, packaging codes, or custom inventory tags associated with perishable or artisanal food items. The database may store appetizing product photography showing food items in styled presentations, along with metadata such as origin information, flavor profiles, pairing suggestions, ingredient lists, and allergen warnings. The advertisement templates may be designed to emphasize the artisanal nature, quality ingredients, or limited availability of specialty food products, with visual elements such as rustic backgrounds, ingredient imagery, or serving suggestions integrated into the designs. A cheese shop owner may use the system to create daily or weekly advertisements featuring seasonal selections, newly arrived imports, or items approaching their optimal consumption window. For example, the owner may scan a wheel of aged Gruyère, select a template featuring a wooden board background with accompaniments, and generate an advertisement that includes the cheese name, country of origin, aging period, tasting notes, suggested wine pairings, and current pricing. The playlist functionality may enable the shop to schedule different content based on mealtimes, displaying breakfast-appropriate items such as fresh pastries and spreads during morning hours, lunch-focused content featuring sandwich ingredients and prepared foods during midday, and dinner-oriented content showcasing premium cheeses, charcuterie, and entertaining essentials during afternoon and evening periods. The cocktail video functionality described in the liquor store context may be adapted to display recipe videos showing how to prepare cheese boards, create charcuterie platters, or incorporate specialty ingredients into home cooking, thereby inspiring customers and demonstrating the versatility of products available in the store.

The operational workflow of the system may encompass a series of coordinated technical processes and data transmissions that can enable seamless advertisement creation and display management. The operational workflow of the system may encompass a series of coordinated technical processes and data transmissions that can enable seamless advertisement creation and display management. When a user initiates product scanning via the client device 702, the device's camera may capture the UPC barcode or other scannable identifier of the product 706, and the application 302 executing on the client device 702 may process the captured image to determine a product identifier. The product identifier may be transmitted to the server 704 via network communication protocols, wherein the transmission may occur over wireless network 110 or wide area network 112 depending on the available connectivity. Upon receiving the product identifier, the server 704 may execute a database query against the database 714 to retrieve associated product information, which may include product name, pricing data, inventory status, and references to available multimedia assets. In one aspect, the server 704 may simultaneously query the third-party platform 712 via API calls to obtain real-time inventory levels, current pricing, or additional product metadata maintained in external systems. The server 704 may aggregate the retrieved data from either or both the database 714 and the third-party platform 712, process this information to ensure data consistency and format compatibility, and transmit the compiled product data back to the client device 702. The application 302 on the client device 702 may receive this product data. In one embodiment, the system may populate the advertisement generation interface 2400 or multi-product advertisement generation interface 2500, automatically filling the title field 2406, subtitle field 2408, price field 2410, and discount field 2412 with the retrieved information.

When the user selects a template from the main template interface 2200, the client device 702 may retrieve the template structure and layout parameters from the server 704, which may include positioning coordinates, text field specifications, image placement zones, and animation sequences. The application 302 may then render a preview of the advertisement by combining the selected template with the product data and any user-specified customizations, wherein this rendering process may occur locally on the client device 702 using the device's graphics processing capabilities. Upon completion of the advertisement creation process, the user may publish the advertisement via the playlist addition button 2414, which may trigger the client device 702 to transmit the finalized advertisement data structure to the server 704 for persistent storage in the database 714.

The user may subsequently create a playlist by accessing the playlist creation method 400, wherein the application 302 may present available content including both user-created advertisements stored in the database 714 and branded content playlists provided by the third-party platform 712. The third-party platform 712 may supply pre-produced video content, brand campaigns, or sponsored advertisements that may be retrieved by the server 704 through API integration and made available for inclusion in user playlists. As the user selects advertisements and branded content for inclusion in the playlist, the application 302 may construct a playlist data structure that may include references to each content element, display duration parameters, sequencing information, and transition effects. When the user publishes the completed playlist via step 408, the client device 702 may transmit the playlist data structure to the server 704, which may store the playlist configuration in the database 714 and associate it with the user's account and designated store locations.

To display the playlist on the external device 708, the user may navigate to the screen-playlist interface 1200 via the application 302 on the client device 702, select the desired screen panel 1102 corresponding to a specific external device 708 at a store location, and activate the playlist by toggling the display toggle 1204 to the on position. This user action may trigger the client device 702 to transmit a display command to the server 704, which may retrieve the complete playlist data structure from the database 714, resolve all content references to obtain the actual multimedia files, and assemble a transmission package containing the playlist content and playback instructions. The server 704 may then transmit this playlist package to the external device 708 via network communication, wherein the transmission may utilize wireless protocols such as Wi-Fi or may leverage existing network infrastructure connecting the external device 708 to the server 704. The external device 708 may receive the playlist package, store the content in local memory, and begin playback according to the specified sequencing and duration parameters, displaying the content on the display 716. Throughout this process, the external device 708 may maintain bidirectional communication with the server 704 to report playback status, confirm content receipt, and receive real-time updates or modifications to the playlist configuration initiated by the user through the application 302 on the client device 702.

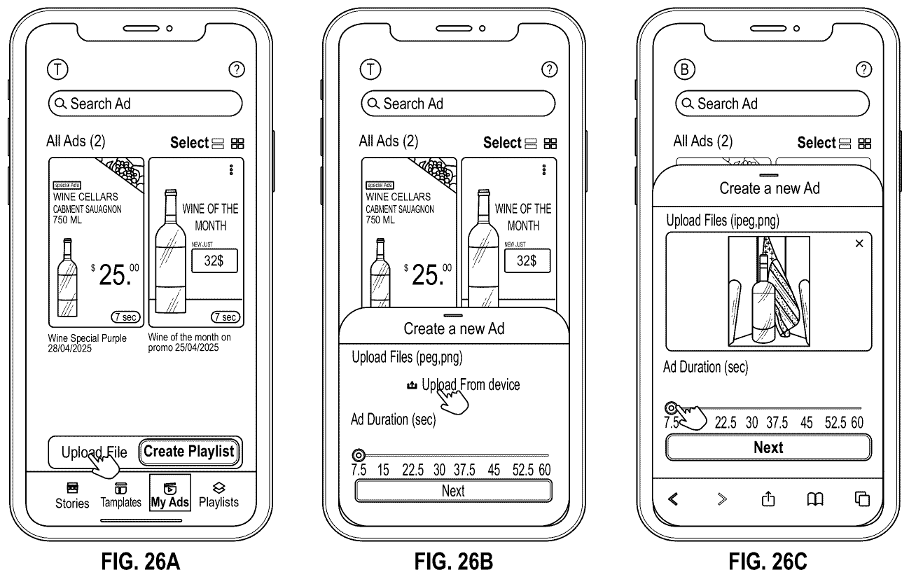

Referring to FIGS. 26A-26C, in one embodiment, the system may provide functionality enabling users to upload custom advertisement content created outside the application 302, thereby allowing retailers to incorporate proprietary marketing materials, professionally produced videos, or unique promotional content into their digital signage playlists. The application 302 may present an upload interface accessible through the navigation toolbar 308 or the main playlist interface 800, wherein the user may initiate the upload process by selecting an upload button or menu option. Upon activation of the upload functionality, the application 302 may prompt the user to select a file from the client device 702, wherein the file selection interface may provide access to the device's local storage, including photo libraries, video folders, document directories, or cloud storage services integrated with the device's operating system. The system may support multiple file formats for upload, including but not limited to video files such as MP4, MOV, AVI, or WMV formats, image files such as JPEG, PNG, GIF, or TIFF formats, and potentially other multimedia formats suitable for display on the external device 708. The upload interface may display thumbnail previews of available files, enabling users to visually identify the desired content before selection, and may include filtering options to narrow the displayed files by type, date, or location. Once a file is selected, the application 302 may display a preview of the uploaded content, allowing the user to verify that the correct file has been chosen before proceeding with the upload process.

Following file selection, the application 302 may present duration configuration controls enabling the user to specify how long the uploaded advertisement should be displayed during playlist playback. In one implementation, the duration configuration may be accomplished through a slider interface element, wherein the user may drag a slider control along a horizontal or vertical axis to adjust the display duration, with the selected duration value displayed numerically adjacent to the slider in seconds or minutes. Alternative duration configuration mechanisms may include increment and decrement buttons that allow users to adjust the duration in fixed intervals such as one-second or five-second increments, a numeric input field wherein users may directly type the desired duration value, a dropdown menu presenting predefined duration options such as 5 seconds, 10 seconds, 15 seconds, or 30 seconds, or a dial or rotary control interface that users may rotate to adjust the duration value. In some embodiments, the system may automatically detect the native duration of video files and pre-populate the duration field with this detected value, while allowing users to override the automatic duration if desired. As an alternative to uploading pre-existing files, the application 302 may provide in-app content creation functionality, wherein users may capture new photographs or videos directly through the application interface without needing to exit to the device's native camera application. When the user selects a camera capture option, the application 302 may activate the camera of the client device 702 and present a camera interface with capture controls, enabling the user to frame and capture a photograph of a product, store display, promotional signage, or any other subject matter suitable for advertisement purposes. The captured image may be immediately available for use in advertisement creation, wherein the application 302 may automatically import the captured photograph into the upload workflow, allowing the user to configure duration settings and add the content to a playlist without requiring manual file selection from device storage.

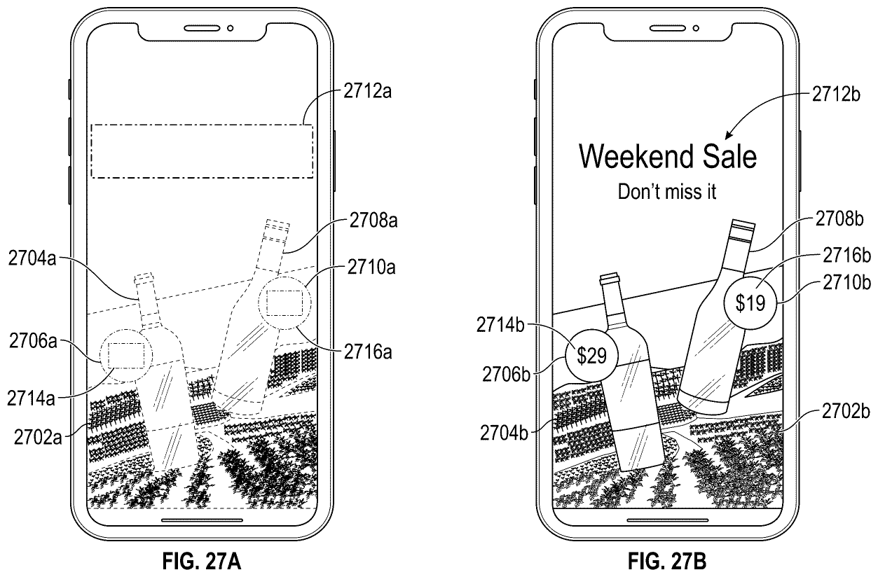

Referring to FIGS. 27A-27B, the system may utilize templates that exist in two distinct states: an unpopulated state and a populated state, wherein the transition from unpopulated template 2702a to populated template 2702b occurs during the advertisement creation workflow as users input product selections and associated information. The unpopulated template 2702a may define a structural framework comprising designated zones, coordinate positions, and placeholder elements that specify where content will be inserted during the population process. Within the unpopulated template 2702a, an unpopulated first product representation 2704a may define a spatial region, coordinate point, or blank area designated to receive product imagery, wherein this unpopulated first product representation 2704a transforms into a populated first product representation 2704b when the system retrieves and inserts a product image from the database 714 based on the product identifier such as a UPC code or SKU number scanned or selected by the user. Similarly, an unpopulated second product representation 2708a may define another spatial region within the unpopulated template 2702a that becomes a populated second product representation 2708b upon insertion of a second product image, and this pattern may be extrapolated to accommodate additional product representations for templates designed to display three, four, or more products simultaneously within a single advertisement frame.

The unpopulated template 2702a may further include marker positioning elements that designate where product-specific information will be displayed in relation to product imagery. An unpopulated first product marker 2706a may define a coordinate position, blank area, or spatial zone maintained in close proximity to the unpopulated first product representation 2704a, wherein this unpopulated first product marker 2706a becomes a populated first product marker 2706b when the system inserts a visual indicator such as a circle, badge, or other graphical element that serves to associate pricing information with the corresponding product. The populated first product marker 2706b may be positioned on or adjacent to the populated first product representation 2704b, creating a visual connection between the product image and its associated pricing data. Similarly, an unpopulated second product marker 2710a may define a coordinate position or spatial zone near the unpopulated second product representation 2708a, which transforms into a populated second product marker 2710b upon insertion of a visual indicator element during the advertisement generation process. The marker elements may serve as anchor points for displaying product-specific information, wherein an unpopulated first product price 2714a represents a data field or display zone associated with the unpopulated first product marker 2706a that becomes a populated first product price 2714b when pricing information is inserted, and wherein an unpopulated second product price 2716a similarly becomes a populated second product price 2716b upon population with pricing data for the second product.

The unpopulated template 2702a may include text handling regions that accommodate descriptive content for the advertisement. An unpopulated text 2712a may define a field, area, or zone within the unpopulated template 2702a configured to receive textual input, wherein this unpopulated text 2712a becomes populated text 2712b when the user or system inserts content such as advertisement titles, subtitles, promotional messaging, or other descriptive information supported by the template structure. The unpopulated text 2712a may be configured to accept various forms of content input beyond strictly textual characters, including formatted text with font styling, color specifications, or size variations as defined by the template design parameters. During the advertisement creation workflow, pricing information for the populated first product price 2714b and populated second product price 2716b may be obtained through multiple data sources, including retrieval from inventory management systems or point-of-sale systems via API integration with the third-party platform 712, or through direct manual entry by the user via input fields presented in the advertisement generation interface 2400 or multi-product advertisement generation interface 2500. The transformation from unpopulated template 2702a to populated template 2702b represents a data mapping and rendering process wherein the application 302 resolves placeholder elements to actual content, retrieves necessary assets from the database 714 or third-party platform 712, applies user-specified customizations, and generates a finalized advertisement ready for inclusion in playlists and display on the external device 708.

In a further embodiment, the system may incorporate artificial intelligence functionality wherein the user may capture or upload a photograph of a product, and the AI tool may automatically process the image to generate a customized advertisement by imposing the product image over a selected or AI-generated background. The AI tool may interpret natural language instructions provided by the user, wherein the user may specify desired visual elements such as background themes, text overlays, color schemes, or audiovisual effects, and the AI may generate the advertisement output according to these specifications. The AI processing may include automatic background removal from the uploaded product image, intelligent placement of the product within the composition, generation of complementary text elements with appropriate typography and positioning, and selection or creation of background imagery that aligns with the user's stated preferences or the product category. Upon generation of the AI-created advertisement, the user may review the output, request modifications through additional natural language prompts, and save the finalized advertisement to their library for inclusion in playlists, thereby streamlining the advertisement creation process through intelligent automation while maintaining user control over the final creative output.

In a further embodiment, the system may include a scheduling module that enables users to configure time-based playlist activation according to temporal parameters including day of the week, time of day, calendar dates, holidays, and sales periods. The scheduling module may provide an interface accessible through the application 302 wherein users may define scheduling rules that specify which playlists should be displayed on which screens at particular times, allowing for automated content rotation without requiring manual intervention. The scheduling functionality may enable users to create scheduling profiles that associate specific playlists with temporal conditions, wherein a user may configure a first playlist to display during morning hours on weekdays, a second playlist to display during evening hours, and a third playlist to display during weekend periods, with the system automatically transitioning between playlists according to the defined schedule. The scheduling module may further accommodate special event scheduling, wherein users may designate certain playlists for display during holiday periods such as Thanksgiving, Christmas, New Year's Eve, or other culturally significant dates, or during promotional sales periods such as Black Friday, end-of-season clearances, or inventory reduction events. The scheduling interface may provide calendar-based visualization tools that display scheduled playlists across a timeline, enabling users to review and modify their scheduling configurations through an intuitive graphical representation. In some aspects, the scheduling module may support location-specific scheduling parameters, wherein users may configure different scheduling rules for different stores or individual screens within their retail network, allowing a user to display region-specific content, accommodate varying store hours across locations, or tailor promotional messaging to local market conditions and customer demographics. The scheduling module may maintain scheduling data in the database 714, wherein the server 704 may continuously monitor current date and time parameters and automatically transmit playlist activation commands to the appropriate external devices 708 when scheduled conditions are met, ensuring that the correct content is displayed at the designated times without requiring real-time user oversight. The scheduling functionality may also provide override capabilities, wherein users may temporarily suspend scheduled playlists to display urgent promotional content or emergency messaging, with the system automatically resuming the scheduled playlist rotation after the override period expires or is manually deactivated by the user.

Various elements, which are described herein in the context of one or more embodiments, may be provided separately or in any suitable subcombination. Further, the processes described herein are not limited to the specific embodiments described. For example, the processes described herein are not limited to the specific processing order described herein and, rather, process blocks may be re-ordered, combined, removed, or performed in parallel or in serial, as necessary, to achieve the results set forth herein.

It will be further understood that various changes in the details, materials, and arrangements of the parts that have been described and illustrated herein may be made by those skilled in the art without departing from the scope of the following claims.

All references, patents and patent applications and publications that are cited or referred to in this application are incorporated in their entirety herein by reference. Finally, other implementations of the disclosure will be apparent to those skilled in the art from consideration of the specification and practice of the disclosure disclosed herein. It is intended that the specification and examples be considered as exemplary only, with a true scope and spirit of the disclosure being indicated by the following claims.

What is claimed is:

1. A system for remote creation of dynamic advertisements, the system comprising:
a client device configured to execute a program, wherein the client device is configured to:
receive selection of one or more templates via the program;
scan one or more scannable elements via the program, wherein each of the one or more scannable elements uniquely corresponds to a product;
retrieve, from an external database, one or more images of the one or more products to import into the one or more templates, wherein the one or more imported images may be reconfigured within the one or more templates;
publish the one or more templates to create one or more advertisements; and
transmit, via wireless communication, the one or more advertisements; and
an external device comprising a display, wherein the external device is configured to:
receive the one or more advertisements from the client device via the wireless communication; and
display the one or more advertisements on the display.

2. The system of claim 1, wherein the external database is stored on a cloud computing platform and comprises a relational database structure with indexed fields including UPC codes, product categories, brand names, and SKU numbers for beverage alcohol products, and wherein the external database stores the one or more images.

3. The system of claim 1, wherein the program is a mobile application configured to access a camera of the client device for barcode scanning functionality and to interface with local device storage for multimedia file access.

4. The system of claim 1, wherein the client device is configured to integrate with an inventory management system via API calls to retrieve real-time inventory levels, current pricing data, and sales performance metrics for automatic advertisement content population.

5. The system of claim 1, wherein the client device is further configured to create one or more playlists comprising the one or more advertisements, and wherein the external device is configured to display the one or more playlists in a continuous loop format.

6. The system of claim 1, wherein the one or more templates comprise configurable components including pixel-coordinate image placement zones, font-specific text field positions for pricing information, and frame-based display duration parameters ranging from 3 to 15 seconds per template scene.

7. The system of claim 1, wherein the program includes one or more stores, wherein each store of the one or more stores corresponds to a physical retail location and is accessible remotely via the client device.

8. The system of claim 7, wherein each store of the one or more stores includes one or more screens corresponding to individual external devices, and wherein the client device is configured to remotely monitor and control the one or more screens.

9. The system of claim 8, wherein the client device is configured to display real-time status information for each screen of the one or more screens, wherein the real-time status information indicates whether each screen is active or inactive based on network connectivity between the system and the corresponding external device.

10. The system of claim 5, wherein the one or more advertisements comprise multi-product advertisements, wherein each multi-product advertisement includes a representative image displaying a plurality of products, one or more product markers positioned on the representative image to indicate locations of individual products, and one or more product modules each associated with a corresponding product marker, wherein each product module includes a product selection field, a price field, and a discount field, and wherein the client device is configured to map each product module to its corresponding product marker in a final rendered advertisement.

11. The system of claim 7, wherein the program is configured to display a main stores interface comprising one or more store buttons each corresponding to a store of the one or more stores, wherein selection of a store button generates a specific store interface displaying one or more screen panels each corresponding to an individual external device at the selected store, wherein selection of a screen panel generates a screen-playlist interface displaying one or more playlist panels and a display toggle, and wherein the client device is configured to display real-time connectivity status for each screen panel indicating whether the corresponding external device maintains an active network connection with the system.

12. The system of claim 5, wherein the one or more playlists comprise a playlist data structure including content references to the one or more advertisements and one or more multimedia files, display duration parameters individually assigned to each content reference, sequencing information defining playback order, and transition effects between content elements, wherein the playlist data structure is stored in a database accessible by the client device, and wherein the external device is configured to receive the playlist data structure, resolve the content references to obtain corresponding multimedia content, and execute sequential playback according to the display duration parameters and sequencing information.

13. A system for remote creation of dynamic advertisements, the system comprising:
a client device configured to execute an application, wherein the client device is configured to:
activate a camera of the client device via the application;
capture an image of a scannable element associated with a product via the camera;
extract a product identifier from the captured image of the scannable element;
transmit the product identifier to a server via wireless communication;
receive, from the server, product data associated with the product identifier,
wherein the product data comprises a product name, pricing information, and one or more stock images;
automatically populate with at least one of the product data an advertisement template to generate an advertisement for the product; and
transmit, via wireless communication, the advertisement to an external device; and
the external device comprising a display, wherein the external device is configured to:
receive the advertisement from the client device via the wireless communication; and
display the advertisement on the display.

14. The system of claim 13, further comprising a server communicatively coupled to a cloud-based database, wherein the server is configured to receive the product identifier from the client device, query the cloud-based database using the product identifier to retrieve the product data, and transmit the product data to the client device.

15. The system of claim 14, wherein the cloud-based database stores product information for a plurality of beverage alcohol products, wherein the product information comprises product identifiers, product names, pricing data, and stock images for each product of the plurality of beverage alcohol products.

16. The system of claim 13, wherein the client device is further configured to create a playlist comprising the advertisement and transmit the playlist to the external device, and wherein the external device is configured to display the playlist in a continuous loop format.

17. The system of claim 16, wherein the playlist comprises branded content provided by third-party suppliers, wherein the branded content comprises pre-produced video advertisements.

18. The system of claim 13, wherein the advertisement template comprises configurable components including image placement zones, text field positions for pricing information, and display duration parameters, and wherein the client device is configured to allow manual modification of the automatically populated product data within the advertisement template.

19. A method for remote creation of dynamic advertisements, the method comprising:
activating a scanning interface via an application;
capturing an image of a scannable element associated with a product;
receiving, from a database, product data based on the product, wherein the product data comprises at least one product image and product information;
receiving selection of an advertisement template comprising one or more unpopulated product representations, one or more unpopulated product markers, and one or more unpopulated product prices, wherein the one or more unpopulated product representations, the one or more unpopulated product markers, and the one or more unpopulated product prices define spatial regions designated to receive content;
automatically populating the one or more unpopulated product representations with the at least one product image to transform the one or more unpopulated product representations into one or more populated product representations;
automatically populating the one or more unpopulated product prices with a product price from the product information to transform the one or more unpopulated product prices into one or more populated product prices, wherein each of the one or more populated product prices is populated within one of the one or more unpopulated product markers to transform the one or more unpopulated product markers to one or more populated product markers; and
generating an advertisement comprising the one or more populated product representations, the one or more populated product markers, and the one or more populated product prices; and
transmitting the generated advertisement to an external device comprising a display.

20. The method of claim 19, wherein the advertisement template further comprises an unpopulated background region that is populated with background imagery or color scheme data to transform the unpopulated background region into a populated background region, and wherein the advertisement template further comprises one or more unpopulated text fields defining spatial regions designated to receive textual content, wherein the one or more unpopulated text fields are automatically populated to transform the one or more unpopulated text fields into one or more populated text fields, wherein the one or more populated text fields comprise at least one of product names, product descriptions, promotional messaging, or category identifiers.
